(19) United States
(12) Patent Application Publication
(10) Pub. No.: US 2024/0082854 A1
(43) Pub. Date: Mar. 14, 2024

(54) METHOD FOR FLOTATION OF A SILICATE-CONTAINING IRON ORE

(71) Applicant: BASF SE, Ludwigshafen (DE)

(72) Inventors: Gabriela Budemberg, Jacarei (BR); Alexej Michailovski, Ludwigshafen (DE); Bettina Sobotka, Lampertheim (DE)

(21) Appl. No.: 18/270,322

(22) PCT Filed: Dec. 22, 2021
(86) PCT No.: PCT/EP2021/087348

§ 371 Date: Jun. 29, 2023

(30) Foreign Application Priority Data
Jan. 4, 2021 (EP) 21150123.4
Jan. 8, 2021 (EP) 21150704.1
Jan. 13, 2021 (EP) 21151460.9

(51) Int. Cl. B03D 1/008; B03D 1/01

(52) U.S. Cl. CPC B03D 1/008; B03D 1/01; B03D 2201/02; B03D 2201/06; B03D 2203/04

(57) ABSTRACT

The invention relates to a method for manufacturing a concentrate enriched in iron mineral content from an ore, which contains an iron mineral and silicate, by a reverse flotation, which method comprises the step of (c) adding a collector composition comprising
(i) an amidoamine, which contains a compound of formula I

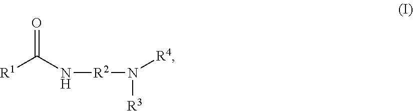

or a salt of a protonated compound of formula I and an anion;
(ii) an ethoxylate, which contains a compound of formula II

R^{E}—O—(—CH₂—CH₂—O—)ₙ—H (II),
wherein R^{E} is a linear or mono-branched aliphatic C₁₀-C₂₀ alkyl or a linear aliphatic C₁₀-C₂₀ alkenyl, and n is an integer from 1 to 12,
   to a prepared aqueous pulp of the ore and optionally one or more flotation auxiliary to obtain an aqueous mixture. Furthermore, the use of the collector composition as a flotation collector is described and the collector composition itself

The present invention relates to a method for manufacturing a concentrate enriched in iron mineral content from an ore, which contains an iron mineral and silicate, by a reverse flotation using a collector composition comprising an amidoamine and an ethoxylate. A further embodiment is a use of the collector composition as a flotation collector. Furthermore, an embodiment is the collector composition itself.

A typical iron ore beneficiation process requires a flotation stage to remove silica (SiO₂) from the valuable iron mineral, e.g. oxides like hematite or magnetite, and thus to obtain a high-grade iron mineral concentrate. A high-grade iron mineral concentrate allows to make high quality steel. Removal of SiO₂ from different ores by froth flotation in combination with hydrophobic amines is a well-known process. Negatively charged silicate particles can be hydrophobized using suitable amines. Injection of air in a flotation cell leads to formation of hydrophobic gas bubbles, which can transport the hydrophobized silicate particles to the top of the flotation cell. The formed froth, which can be stabilized by a suitable chemical acting as a froth regulator, contains the hydrophobized silicate particles. Finally, the froth will be removed from the top and the enriched mineral is left at the bottom of the flotation cell.

U.S. Pat. No. 2,278,060 A relates to a use of reaction products of higher fatty acids or esters and polyamines represented by the general formula H₂N—(CₙH₂ₙ—NH—)ₓ—CₘH₂ₘ—NH₂ for flotation of acidic ore material. In an example, a sample of magnetic separation plant tailings with about 23% Fe and consisting of magnetite, limonite and quartz is floated with the acetate of the reaction product of mixed polyethylene polyamines and coconut oil and a higher alcohol as a frother for flotation of silica from an iron ore.

U.S. Pat. No. 4,301,004 A relates to a beneficiation of phosphate ore by the flotation of siliceous material. The utilization of a condensate of N-aminoethylpiperazine with a fatty acid or fatty acid ester improves the separation of phosphate from silica. This improvement is especially great in the presence of a co-collector consisting of a polyethylenepolyamine condensed with a fatty acid

WO 2011-083136 A1 relates to a flotation process for recovering feldspar from a feldspar containing feed material, comprising the following steps: (1) forming an aqueous suspension of a feldspar containing feed material, in the absence of hydrofluoric acid, wherein the suspension comprises from 0.004 to 0.3 wt. % of a flotation reagent comprising: (a) one or more amines, containing at least one aliphatic hydrocarbon chain, linear or branched, saturated or unsaturated, comprising 8 to 50 carbon atoms, or a salt thereof and (b) one or more primary, secondary or tertiary alcohols, containing at least one aliphatic hydrocarbon chain, linear or branched, saturated or unsaturated, comprising 8 to 50 carbon atoms; the ratio of (a) to (b) ranging from 500:1 to 1:40 by weight; (2) agitating the obtained suspension to produce a feldspar containing fraction, and (3) separating the feldspar containing fraction.

US 2014-048454 A1 relates to fatty amidoamine collectors for the beneficiation by flotation of aqueous suspensions of ores, the use of said fatty amidoamine collectors in flotation processes for the beneficiation of ores, more particularly in reverse flotation processes for the beneficiation of silicates containing-ore. The amidoamine collector is at least one compound of formula 1

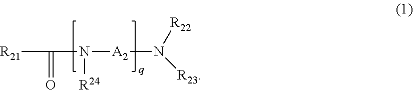

In its examples, the following amidoamine collectors are employed for an inverse flotation of calcium carbonate at a neutral pH: rapseed oil, N-(3-(dimethylaminopropyl)amide (CAS-No. 85408-42-0); tall oil, N-(3-(dimethylaminopropyl)amide (CAS-No. 68650-79-3) and fish oil, N-(3-(dimethylaminopropyl)amide (CAS-No. 97552-95-9). In some examples, the amidoamine is combined with a further cationic collector, i.e. N,N′,N′-trihydroxyethyl N-tallow propylene diamine (CAS-No. 61790-85-0). In one example, terpineol is added as a well-known foamer. In its general specification, a combination of the amidoamine with a second cationic collector, i.e. a fatty alkoxylated polyamine of formula 2

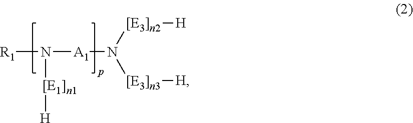

is disclosed.

US 2014-048453 A1 relates to fatty alkoxylated polyamine collectors for the beneficiation by flotation of aqueous suspensions of ores, the use of said fatty alkoxylated polyamine collectors in flotation processes for the beneficiation of ores, more particularly in reverse flotation processes for the beneficiation of silicates containing-ores. The fatty alkoxylated polyamine collector is of formula 1

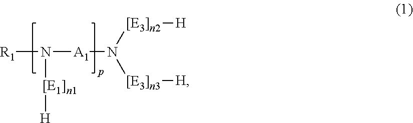

In its examples, the following amidoamine collector is employed for an inverse flotation of calcium carbonate at a neutral pH: rapseed oil, N-(3-(dimethylaminopropyl)amide (CAS-No. 85408-42-0). This amidoamine collector is also employed in combination with N,N′,N′-trihy-droxyethyl N-tallow propylene diamine (CAS-No. 61790-85-0). In its general specification, a combination of the fatty alkoxylated polyamine with a second cationic collector, i.e. an amidoamine of formula 2

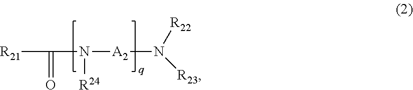

is disclosed.

US 2014-144290 A1 relates to collector compositions and methods for making and using them. The collector composition includes one or more amidoamines of formula I

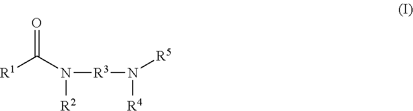

and one or more etheramines having formulae II or III

R⁶—R⁷—NH₂ (II)

R⁸—O—R⁹—NH—R¹⁰—NH₂ (III).

A liquid suspension or slurry comprising one or more particulates can be contacted with the collector to produce a treated mixture. A product can be recovered from the treated mixture that includes a purified liquid having a reduced concentration of the particulates relative to the treated mixture, a purified particulate product having a reduced concentration of liquid relative to the treated mixture, or both. In its examples, the inverse flotation of an iron ore at a pH of 10.5 with removal of SiO₂ via the froth is shown inter alia with tall oil fatty acid 1,3-diamine pentane alone as well as in combination with an etheramine. Furthermore, a tall oil fatty acid diethylenetriamine amide is shown alone as well as in combination with an etheramine.

US 2015-0096925 A1 relates to collector compositions and methods for making and using same to purify one or more crude materials. The collector composition can include one or more amidoamines having the formula I

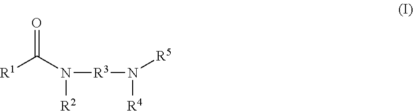

and one or more amines having the formula IV

R⁶—NH₂ (IV),

where a weight ratio of the amidoamine to the amine can be about 99:1 to about 1:99. In its example 1, a coconut fatty acid diethylenetriamine amidoamine neutralized with glacial acetic acid and a BTGE frother are used in an inverse flotation of a phosphate ore for removal of silica at a neutral pH. In its example 2, a coconut fatty oil diethylenetriamine amidoamine neutralized with glacial acetic acid and a BTGE frother are used in an inverse flotation of a phosphate ore for removal of silica at a neutral pH. In its example 3, a tall oil fatty acid diethylenetriamine neutralized with glacial acetic acid and a BTGE frother are used for an inverse flotation of a phosphate ore for removal of silica at a neutral pH. Other amidoamines similarly employed are lauric acid diethylenetriamine amidoamine and a rosin acid tetraethylenepentamine amidoamine. Some examples provide also a combination of an amidoamine with an amine such as an etheramine composed of 95 wt. % of 3-(8-methylnonoxy)propan-1-amine and 3 wt. % of 8-methylnonan-1-ol, such as cocoamine or such as dodecylamine.

WO 2016/041916 A1 relates to a use of branched fatty alcohol based compounds selected from the group of fatty alcohols with 12-16 carbon atoms having a degree of branching of 1-3, and their alkoxylates with a degree of ethoxylation of up to 3, as secondary collectors for the froth flotation of non-sulfide ores, in combination with a primary collector selected from the group of amphoteric and anionic surface active compounds. In the examples, fatty alcohol ethoxylates based on an alcohol with a degree of branching of 3 and 2.2 are performing superior to fatty alcohol ethoxylates based on an alcohol with a degree of branching of 0.6 or 0 at the flotation of an apatite-containing ore in combination with an amphoteric collector, i.e. N-[2-hydroxy-3-(C₁₂-C₁₆-alkoxy)propyl]-N-methyl glycinate, an a frother.

WO 2016/065189 A1 relates to compositions, aqueous mixtures that include the composition and an ore, and methods for making and using same. The composition can include an organic acid and a polyamidoamine. The polyamidoamine can have the chemical formula A

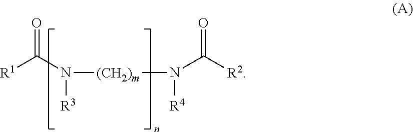

In the chemical formula A, R¹ and R² can independently be a saturated or unsaturated, substituted or unsubstituted, linear or branched, cyclic, heterocyclic, or aromatic hydrocarbyl group, R³ and R⁴ can independently be hydrogen or a saturated or unsaturated, substituted or unsubstituted, linear or branched, cyclic, heterocyclic or aromatic hydrocarbyl group, each m can be an integer of 1 to 5 and n can be an integer of 2 to 8. The aqueous mixture can include an ore, water and the composition.

WO 2019/113082 A1 relates to a collector composition and methods for making and using the same are provided. The collector is synthesized from one or more tall oil fatty acids and one or more polyamines. A liquid suspension or slurry comprising one or more particulates may be contacted with the collector to produce a treated mixture. The collector contains sub-components with amidoamine and imidazoline functionalities which provide superior recovery of desired minerals over known methods. In its examples, oleic acid is condensed with triethylenetetramine. The reaction products are employed for flotation of a copper ore alone, in combination with a frother, i.e. Dowfroth 250 and/or methyl isobutyl carbinol, in combination with sodium isopropyl xanthate or in combination with the frother and sodium isopropyl xanthate.

International PCT application WO 2021/005020 relates to a method for manufacturing a concentrate enriched in iron mineral content from an ore, which contains an iron mineral and silicate, by a reverse flotation, which method comprises the step of
(c) adding a compound of formula I

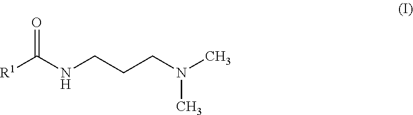

wherein R¹ is a linear C₁₇ alkenyl, a linear C₁₇ alkyl or a linear C₁₅ alkyl, or
a salt of a protonated compound of formula I and an anion, to a prepared aqueous pulp of the ore and optionally one or more flotation auxiliaries to obtain an aqueous mixture. In its examples, the amidoamine employed for flotation of a haematite ore is a reaction product from the condensation of soy oil fatty acid and N,N-dimethylproapne-1,3-diamine. In its general specification, a co-collector is proposed as one of several flotation auxiliaries. A co-collector, which is cationic, non-ionic or anionic is proposed. A non-ionic co-collector is for example C₉-C₁₅ alkyl alcohol, which is branched, or ethoxylated C₉-C₁₅ alkyl alcohol, which is branched and ethoxylated with 2 to 4 mole ethylene oxide.

U.S. Pat. No. 6,204,234 relates to cleaning compositions, including laundry, dishwashing, hard surface cleaner, oral/ dental cleaning compositions, comprising a proteinic substrate based oxygenase, for cleaning proteic based stains and providing sanitisation of the treated surfaces, as well as whitening performance when formulated as a laundry detergent composition. However, it does not disclose the combined use of ethoxylates and amidoamines, nor does it indicate any optional use for flotation.

There is still a need for improved methods in inverse flotation of ores containing iron mineral and silicate. Especially the quality of ores has been decreasing. With higher SiO₂ content in the ore, a selective removal of silicate is more difficult than in the past with ores of a lower SiO₂ content. Furthermore, not only a SiO₂ content is higher, but other contaminants are also present like kaolinite and dolomite, which makes a flotation process more difficult. On one side, a loss of iron mineral in the flotation process should be avoided, i.e. a high recovery, and on the other side, SiO₂ content should be decreased in a concentrate enriched in iron mineral content to a low level, i.e. selectivity. Especially for direct reduction processes using the concentrate, a low SiO₂ content is desirable. Typically, a mine as an ore processing site will set a maximum level of residual SiO₂ content that is allowed to remain in the concentrate at the end of the flotation process. This may for instance be 2.5 wt. % (% by weight), especially 2.0 wt. %. The target is generally to at least achieve this maximum silica level without significantly losing any of the iron mineral content. A better recovery in combination with a comparable or a better selectivity reduces iron mineral losses in the tailings and leads to economic benefits.

It is an object of the present invention to provide a method for manufacturing a concentrate enriched in iron mineral content with a high recovery of iron mineral from the applied ore and a low content of SiO₂ from the applied ore. Furthermore, it is attractive if the overall amount of employed collector can be reduced. At the same time, it is an advantage if a material applied in the method can economically be manufactured in a chemically relatively simple reaction and the reaction product needs no or essentially no purification steps.

The object is achieved, according to the invention, by a method for manufacturing a concentrate enriched in iron mineral content from an ore, which contains an iron mineral and silicate, by a reverse flotation, which method comprises the step of
(c) adding a collector composition comprising
   (i) an amidoamine, which contains a compound of formula I

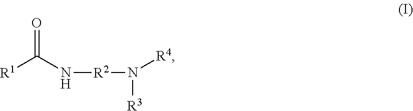

wherein
R¹ is a linear or branched aliphatic C₇-C₁₉ alkyl or a linear C₇-C₁₉ aliphatic alkenyl,
R² is a linear or branched aliphatic C₂-C₆ alkylene,
R³ and R⁴ are independently from each other H, C₁-C₂ alkyl or a substituent of formula I-S

*-[—(CH₂—)ₚ—NH—]_{q}—(—CH₂—)ₚ—NH₂ (I-S),
wherein
p is 2, 3 or 4,
q is 0, 1, 2 or 3, and
* represents the connecting site of the substituent, or
a salt of a protonated compound of formula I and an anion;
(ii) an ethoxylate, which contains a compound of formula II

R^{E}—O—(—CH₂—CH₂—O—)ₙ—H (II),
wherein
R^{E} is a linear or mono-branched aliphatic C₁₀-C₂₀ alkyl or a linear aliphatic C₁₀-C₂₀ alkenyl,
n is an integer from 1 to 12,
to a prepared aqueous pulp of the ore and optionally one or more flotation auxiliary to obtain an aqueous mixture.

The method is characterized by that the collector composition comprises
(ii) an ethoxylate, which contains a compound of formula II.

Preferably, the method for manufacturing a concentrate enriched in iron mineral content from an ore, which contains an iron mineral and silicate, comprises the steps of
(a) providing the ore, which contains an iron mineral and silicate,
(b) preparing from the provided ore by addition of water and optionally one or more flotation auxiliaries an aqueous pulp,
(c) adding the collector composition to the prepared aqueous pulp of the ore and optionally one or more flotation auxiliaries to obtain an aqueous mixture,
(d) aerating the aqueous mixture in a flotation cell to generate a froth, which is enriched in silicate content, and removing the generated froth from the flotation cell,
(e) obtaining from the flotation cell the concentrate enriched in iron mineral content.

The steps (a), (b), (c), (d) and (e) describe more detailed the reverse flotation.

The ore, which contains an iron mineral and silicate (SiO₂), is for example from a magmatic deposit or from a sedimentary deposit. Igneous ores (e.g. Kiruna type) always contain iron as magnetite (Fe₃O₄), while sedimentary (banded iron formations=BIF) ores may also contain iron mainly as magnetite, mainly as haematite, or as a mixture of both. Where iron is mainly contained as magnetite, crushing and wet grinding are often followed by a magnetic separation and sometimes the magnetic concentrate is further treated by flotation. Where iron is mainly or to a significant degree contained as haematite and the iron content of the ore itself is below 50-55 wt. %, the ore is often crushed, wet ground and subjected to flotation. Itabirite is a specific type of sedimentary iron ore, frequently found in the Iron Quadrangle of Brazil but also encountered and exploited in other locations worldwide. The step (a) of providing an ore comprises for example also a crushing or a grinding respectively milling of the ore. In case of an ore from a magmatic deposit, the step of providing the ore comprises for example also a crushing of the ore, a grinding respectively milling of the ore and a removal of magnetic parts by magnetic separation. In case of an ore from a sedimentary deposit, the step of providing the ore comprises for example a crushing of the ore, particularly a crushing of the ore and a wet grinding of the ore. Preferably, the step (a) of providing of the ore results in ore particles, which have a particle size allowing 60 to 100 wt. % (% by weight) of the particles based on the overall weight of the particles to pass a 100 μm steel mesh sieve as measured by standard dry sieving.

The ore contains for example 20 to 80 wt. % of silicate based on the weight of the ore, particularly 25 to 75 wt. %, very particularly 30 to 55 wt. % and especially 30 to 40 wt. %. The calculation is performed on basis of dry ore.

Preferably, the iron mineral consists out of 90 to 100 wt. % by weight of iron oxide based on all iron mineral in the ore. Very preferably, the iron mineral consists out of at least 97 to 100 wt. % of iron oxide, particularly preferably out of 99 to 100 wt. %. Typical iron oxides are hematite (Fe₂O₃ with 69.9 wt. % of iron content based on the weight of Fe₂O₃), magnetite (Fe₃O₄ with 72.4 wt. % iron content based on the weight of Fe₃O₄), goethite (alpha-Fe(O)OH) with 62.9 wt. % iron content based on the weight of alpha-Fe(O)OH) or a mixture thereof, particularly the iron oxides are hematite, magnetite or a mixture of both. The weight of iron content is similar to a weight content of Fe atoms.

A typical ore comprises between 40 to 70 wt. % of hematite and 30 to 50 wt. % of silica, particularly 45 to 65 wt. % of hematite and 30 to 45 wt. % of silica. The calculation is performed on basis of dry ore. The ore is preferably an itabirite type iron ore.

Preferred is an ore, which comprises iron mineral, wherein more than 50 wt. % of the comprised iron mineral is an iron oxide, which is hematite. Very preferred, more than 70 to 100 wt. % is an iron oxide, which is hematite.

The collector composition acts in the method as a collector for froth flotation. Some might call the amidoamine a primary collector and the ethoxylate a secondary collector, wherein the ethoxylate supports or boosts the performance of the amidoamine.

Linear aliphatic alkyl or linear aliphatic alkenyl herein means that the aliphatic alkyl or the aliphatic alkenyl possesses only carbon atoms, which are covalently bound to one other carbon atom or two other carbon atoms.

Branched aliphatic alkyl herein means that the aliphatic alkyl possesses at least one carbon atom, which is covalently bound to three different carbon atoms or is covalently bound to four different carbon atoms.

Mono-branched aliphatic alkyl herein means that the aliphatic alkyl possesses only one carbon atom, which is covalently bound to three other carbon atoms, and is free of a carbon atom, which is covalently bound to four other carbon atoms.

Linear aliphatic alkylene herein means that the aliphatic alkylene possesses only carbon atoms, which are covalently bound to one other carbon atom or two other carbon atoms.

Branched aliphatic alkylene herein means that the aliphatic alkylene possesses at least one carbon atom, which is covalently bound to three different carbon atoms or is covalently bound to four different carbon atoms.

Mono-branched alkylene herein means that the alkylene possesses only one carbon atom, which is covalently bound to three other carbon atoms, and is free of a carbon atom, which is covalently bound to four other carbon atoms.

Unsubstituted herein means that an alkyl or an alkylene is free of substituents different to a carbon atom or a hydrogen atom. Accordingly, the unsubstituted alkyl or the unsubstituted alkylene is composed only of carbon atoms and hydrogen atoms. The unsubstituted alkyl or the unsubsituted alkylene can still be branched.

A linear aliphatic C₇-C₁₉ alkyl is for example n-hept-1-yl, n-oct-1-yl, n-non-1-yl, n-dec-1-yl, n-undec-1-yl, n-dodec-1-yl, n-tridec-1-yl, n-tetradec-1-yl, n-pentadec-1-yl, n-hexadec-1-yl, n-heptadec-1-yl, n-octadec-1-yl, n-nonadecy-1-yl or a mixture thereof.

A branched aliphatic C₇-C₁₉ alkyl is for example iso-heptyl, particularly 1-methyl-hex-1-yl, 5-methyl-hex-1-yl or 1-ethyl-pent-1-yl, iso-octyl, particularly 1-methyl-hept-1-yl or 6-methyl-hept-1-yl, iso-nonyl, particularly 1-methyl-oct-1-yl or 7-methyl-oct-1-yl, iso-decyl, particularly 1-methyl-non-1-yl, 8-methyl-non-1-yl or 1-propyl-hex-1-yl, iso-undecyl, particularly 1-methyl-dec-1-yl, 9-methyl-dec-1-yl, 3,7-dimethyl-non-1-yl, 1,5,7-trimethyl-oct-1-yl, 1-ethyl-non-1-yl, 1-ethyl-2-methyl-oct-1-yl, 1,3-diethyl-hept-1-yl or 1-butyl-hept-1-yl, iso-dodecyl, particularly 1-methyl-undec-1-yl, 10-methyl-undec-1-yl, 1,3,7-trimethyl-non-1-yl, 1,3,5,7-tetramethyl-oct-1-yl, 1-ethyl-dec-1-yl, 1, 1-diethyl-oct-1-yl or 1-propyl-non-1-yl, iso-tridecyl, particularly 1-methyl-dodec-1-yl, 11-methyl-dodec-1-yl, 1,5,9-trimethyl-dec-1-yl, 1,3,5,7-tetramethyl-non-1-yl, 1-ethyl-undec-1-yl, 6-ethyl1-methyl-dec-1-yl, 1-(1-methylpropyl)non-1-yl, 1-butyl-1-ethyl-5-methyl-hex-1-yl, 1-pentyl-oct-1-yl or 1-hexyl-hept-1-yl, iso-tetradecyl, particularly 1-methyl-tridec-1-yl, 12-methyl-tridec-1-yl, 2,6,10-trimethyl-undec-1-yl, 1-propyl-undec-1-yl or 2-hexyl-oct-1-yl, iso-pentadecyl, particularly 1-methyl-tetradec-1-yl, 1 3-methyl-tetradec-1-yl, 1,3,7-trimethyl-dodec-1-yl, 3,7,11-trimethyl-dodec-1-yl, 1-ethyl-tridec-1-yl, 1-butyl-undec-1-yl or 1-hexyl-non-1-yl, iso-hexadecyl, particularly 1-methyl-pentadec-1-yl or 14-methyl-pentadec-1-yl, iso-heptadecyl, particularly 1-methyl-hexadec-1-yl or 15-methyl-hexadec-1-yl, iso-octadecyl, particularly 1-methyl-heptadec-1-yl or 16-methyl-heptadec-1-yl, iso-nonadecyl, particularly 1-methyloctadec-1-yl, 17-methyl-octadec-1-yl or 1-octyl-undec-1-yl, or a mixture thereof.

A linear aliphatic C₇-C₁₉ alkenyl is for example n-dec-9-en-1-yl, a C₁₇ alkenyl, particularly (8Z)-heptadec-8-en-1-yl, (8E)-heptadec-8-en-1-yl, (8Z,11Z)-heptadec-8, 11-dien-1-yl or (8Z,11Z,14Z)-heptadec-8,11,14-trien-1-yl, or a mixture thereof.

R¹ is preferably a linear or branched aliphatic C₁₁-C₁₉ alkyl or a linear C₁₁-C₁₉ aliphatic alkenyl. More preferably, R¹ is a linear or branched aliphatic C₁₁-C₁₇ alkyl or a linear C₁₁-C₁₇ aliphatic alkenyl. Very preferably, R¹ is a linear aliphatic C₁₅-C₁₇ alkyl or a linear C₁₅-C₁₇ aliphatic alkenyl. Particularly, R¹ is a linear aliphatic C₁₅-C₁₇ alkyl or a linear C₁₇ aliphatic alkenyl.

R¹ is preferably a linear or branched aliphatic unsubstituted C₁₁-C₁₉ alkyl or a linear unsubstituted C₁₁-C₁₉ aliphatic alkenyl. More preferably, R¹ is a linear or branched aliphatic unsubstituted C₁₁-C₁₇ alkyl or a linear C₁₁-C₁₇ aliphatic unsubstituted alkenyl. Very preferably, R¹ is a linear aliphatic unsubstituted C₁₅-C₁₇ alkyl or a linear C₁₅-C₁₇ aliphatic unsubstituted alkenyl. Particularly, R¹ is a linear aliphatic unsubstituted C₁₅-C₁₇ alkyl or a linear C₁₇ aliphatic unsubstituted alkenyl.

A linear or branched aliphatic C₂-C₆ alkylene is for example ethylene, prop-1,3-diyl, 1-methyl-ethylene, but-1,4-diyl, 1-methylprop-1,3-diyl, 2-methyl-1,3-diyl, 1-ethylethylene, pent-1,5-diyl, 1-methyl-but-1,4-diyl, 2-methyl-but-1,4-diyl, 1,2-dimethyl-prop-1,3-diyl, 1-ethyl-prop-1,3-diyl, 2-ethyl-prop-1,3-diyl, hex-1,6-diyl, 1-methylpent-1,5-diyl, 2-methylpent-1,5-diyl, 3-methylpent-1,5-diyl, 1-ethyl-but-1,4-diyl, 2-ethyl-but-1,4-diyl or a mixture thereof.

R² is preferably a linear or branched C₂-C₅ alkylene. More preferably, R2 is a linear or mono-branched C₂-C₅ alkylene. Very preferably, R² is a linear or mono-branched C₂-C₃ alkylene or a linear or mono-branched C₅ alkylene. Particularly, R² is a linear C₂ alkylene or a mono-branched C₅ alkylene.

R² is preferably a linear or branched aliphatic C₂-C₅ alkylene. More preferably, R₂ is a linear or mono-branched aliphatic C₂-C₅ alkylene. Very preferably, R² is a linear or mono-branched aliphatic C₂-C₃ alkylene or a linear or mono-branched aliphatic C₅ alkylene. Particularly, R² is a linear aliphatic C₂ alkylene or a mono-branched aliphatic C₅ alkylene.

R² is preferably a linear or branched aliphatic unsubstituted C₂-C₅ alkylene. More preferably, R₂ is a linear or mono-branched aliphatic unsubstituted C₂-C₅ alkylene. Very preferably, R² is a linear or mono-branched aliphatic unsubstituted C₂-C₃ alkylene or a linear or mono-branched aliphatic unsubstituted C₅ alkylene. Particularly, R² is a linear aliphatic unsubstituted C₂ alkylene or a mono-branched aliphatic unsubstituted C₅ alkylene.

C₁-C₂ alkyl is methyl or ethyl.

p is preferably 2 or 3. More preferably, p is 2.

q is preferably 0, 1 or 2. More preferably, q is 0 or 1. Very preferably, q is 0.

R³ is preferably H, methyl or ethyl. More preferably, R³ is H or methyl. Very preferably, R³ is H.

Preferred is a method, wherein R³ is H or C₁-C₂ alkyl.

R⁴ is preferably H, C₁-C₂ alkyl or a substituent of formula I-S, wherein p is 2 or 3 and q is 0, 1, 2 or 3. More preferably, R⁴ is H, C₁-C₂ alkyl or a substituent of formula I-S, wherein p is 2 or 3 and q is 0, 1 or 2. Very preferably, R⁴ is H, methyl or a substituent of formula I-S, wherein p is 2 or 3 and q is 0, 1 or 2. Particularly, R⁴ is H, methyl or a substituent of formula I-S, wherein p is 2 and q is 0, 1 or 2. More particularly, R⁴ is H, methyl or a substituent of formula I-S, wherein p is 2 and q is 0 or 1. Very particularly, R⁴ is H or methyl.

Preferred is a method, wherein p is 2 and q is 1, 2 or 3.

A compound of formula I, wherein R¹ is linear n-heptadec-1-yl, R² is prop-1,3-diyl and R³ and R⁴ are C₁ alkyl, is depicted below

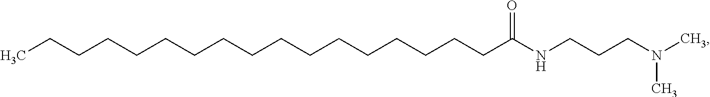 [SMILES: CCCCCCCCCCCCCCCCCC(=O)NCCCN(C)C]

and a chemical name is N-[3-(dimethylamino)propyl]octadecanamide.

A compound of formula I, wherein R¹ is n-pentadec-1-yl, R² is prop-1,3-diyl and R³ and R⁴ are C₁ alkyl, is depicted below

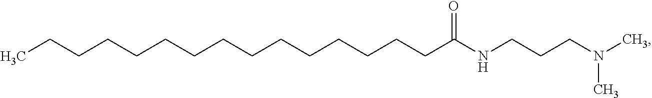 [SMILES: CCCCCCCCCCCCCCCC(=O)NCCCN(C)C]

and a chemical name is N-[3-(dimethylamino)propyl]hexadecanamide.

A compound of formula I, wherein R¹ is linear C₁₇ alkenyl, which is (8Z)-heptadec-8-en-1-yl, R² is prop-1,3-diyl and R³ and R⁴ are C₁ alkyl, is depicted below

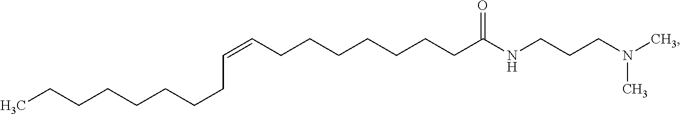 [SMILES: CCCCCCCC/C=C\CCCCCCCC(=O)NCCCN(C)C]

and a chemical name is (Z)—N-[3-(dimethylamino)propyl]octadec-9-enamide.

A compound of formula I, wherein R¹ is linear C₁₇ alkenyl, which is (8Z,11Z)-heptadec-8,11-dien-1-yl, R² is prop-1,3-diyl and R³ and R⁴ are C₁ alkyl, is depicted below

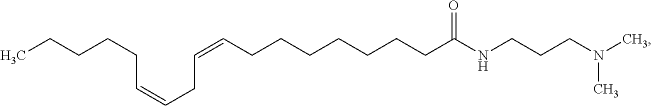 [SMILES: CCCCC/C=C\C/C=C\CCCCCCCC(=O)NCCCN(C)C]

and a chemical name is (9Z,12Z)—N-[3-(dimethylamino)propyl]octadeca-9,12-dienamide.

A compound of formula I, wherein R¹ is linear C₁₇ alkenyl, which is (8Z,11Z,14Z)-heptadec-8,11,14-trien-1-yl, R² is prop-1,3-diyl and R³ and R⁴ are C₁ alkyl, is depicted below

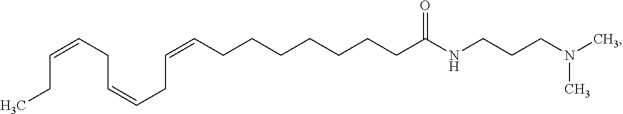 [SMILES: CC/C=C\C/C=C\C/C=C\CCCCCCCC(=O)NCCCN(C)C]

and a chemical name is (9Z,12Z,15Z)—N-[3-(dimethylamino)propyl]octadeca-9,12,15-trienamide.

A compound of formula I, wherein R¹ is linear C₁₇ alkenyl, which is (8Z)-heptadec-8-en-1-yl, R² is prop-1,3-diyl and R³ and R⁴ are H, is depicted below

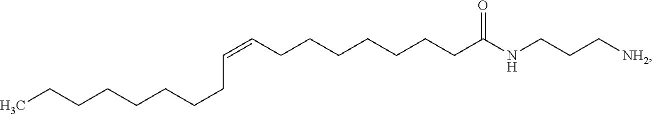 [SMILES: CCCCCCCC/C=C\CCCCCCCC(=O)NCCCN]

and a chemical name is (Z)—N-(3-aminopropyl)octadec-9-enamide.

A compound of formula I, wherein R¹ is linear C₁₇ alkenyl, which is (8Z)-heptadec-8-en-1-yl, R² is 1-ethyl-prop-1,3-diyl and R³ and R⁴ are H, is depicted below

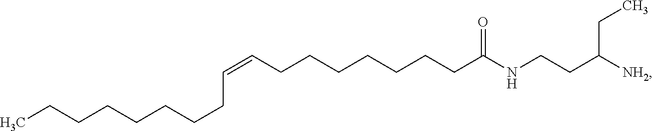 [SMILES: CCCCCCCC/C=C\CCCCCCCC(=O)NCCC(N)CC]

and a chemical name is (Z)—N-(3-aminopentyl)octadec-9-enamide.

A compound of formula I, wherein R¹ is linear C₁₇ alkenyl, which is (8Z)-heptadec-8-en-1-yl, R² is ethylene, R³ is H, and R⁴ is a formula I-S with p=2 and q=0, is depicted below

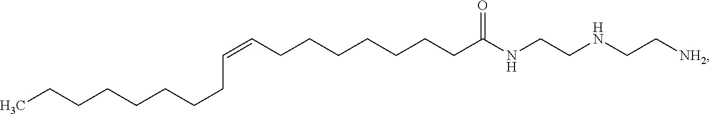 [SMILES: CCCCCCCC/C=C\CCCCCCCC(=O)NCCNCCN]

and a chemical name is (Z)—N-[2-(2-aminoethylamino)ethyl]octadec-9-enamide.

The anion is the deprotonated form of an acid A(-H)p, wherein —H represents an acidic proton and p the number of acidic protons of the acid A(-H)p. Depending on the acid strength of the acid A(-H)p, some acidic protons of the acid A(-H)p might not be deprotonated in a salt with a compound of formula I.

A salt of a mono-protonated compound of formula I and the anion is for example also expressed by formula I-t1-1+

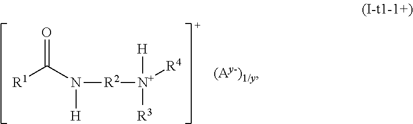

wherein A represents the anion, y is an integer, which is at least 1, and y represents the negative charge of the anion. y is not higher than p, which is the number of acidic protons of the acid A(—H)p. Preferred is an anion, which is a deprotonated acid A(—H)p, wherein p is 1, 2 or 3 and y is 1 for p=1, y is 1 or 2 for p=2 and y is 1, 2 or 3 for p=3. In case of R³ and/or R⁴ being independently from each other a substituent of formula I-S, the one or more nitrogen atoms of formula I-S are in an equilibrium with the nitrogen atom substituted by R², R³ and R⁴ for being protonated. This is well-known as tautomerism. In case of R³ and/or R⁴ being independently from each other a substituent of formula I-S, the compound of formula I can be twice protonated and carries two positive charges. Accordingly, the one or more nitrogen atoms of formula I-S and the nitrogen atom substituted by R², R³ and R⁴ are overall twice protonated and individually in an equilibrium for being protonated. In analogy, the compound of formula I can be protonated more than twice and up to the number of nitrogen atoms in the substituents of formula I-S plus one for the nitrogen atom substituted by R², R³ and R⁴. However, it is more economic and environmental beneficial if the compound of formula I is not protonated and thus less up to no anions are introduced by the compound of formula I into the method for manufacturing a concentrate. Preferably, the compound of formula I is protonated not more than three-times, twice or once, more preferably not more than twice or once, most preferably not more than once and particularly the compound of formula I is free from protonation respectively the compound of formula I is not a salt.

The anion is for example C₁-C₁₈ carboxylate, fluoride, chloride, bromide, iodide, sulfonate, hydrogensulfate, sulfate, dihydrogenphosphate, hydrogenphosphate, phosphate, nitrate, hydrofluorosilicate or fluorosilicate. C₁-C₁₈ carboxylate is for example an aliphatic or olefinic carboxylate, preferably an aliphatic C₁-C₁₃ carboxylate, very preferably an aliphatic C₁-C₆ carboxylate and especially formate, acetate or proprionate. Preferred is C₁-C₁₈ carboxylate, fluoride, chloride, sulfonate, hydrogensulfate, sulfate, dihydrogenphosphate, hydrogenphosphate, phosphate or nitrate. Very preferred is aliphatic or olefinic C₁-C₁₈ carboxylate, particularly preferred is formate, acetate or proprionate.

Preferred is a method, wherein the anion is C₁-C₁₈ carboxylate, fluoride, chloride, bromide, iodide, sulfonate, hydrogensulfate, sulfate, dihydrogenphosphate, hydrogenphosphate, phosphate, nitrate, hydrofluorosilicate or fluorosilicate.

A linear or mono-branched aliphatic C₁₀-C₂₀ alkyl is for example n-decyl, particularly n-dec-1-yl or n-dec-2-yl, or mono-branched iso-decyl, particularly 2-methyl-non-1-yl, 8-methyl-non-1-yl or 3-propyl-hept-1-yl; n-undecyl, particularly n-undec-1-yl or n-undec-2-yl, or mono-branched isoundecyl, particularly 2-methyl-dec-1-yl or 9-methyl-dec-1-yl; n-dodecyl, particularly n-dodec-1-yl or n-dodec-2-yl, or mono-branched iso-dodecyl, particularly 2-methyl-undec-1-yl, 9-methyl-undec-1-yl, 2-ethyl-dec-1-yl or 2-butyl-oct-1-yl; n-tridecyl, particularly n-tridec-1-yl or n-tridec-2-yl, or mono-branched iso-tridecyl, particularly 2-methyl-dodec-1-yl, 11-methyl-dodec-1-yl, 2-ethyl-undec-1-yl or 2-propyl-dec-1-yl; n-tetradecyl, particularly n-tetradec-1-yl or n-tetradec-2-yl, or mono-branched iso-tetradecyl, particularly 2-methyl-tridec-1-yl, 12-methyl-tridec-1-yl, 2-ethyl-dodec-1-yl, 2-pentyl-non-1-yl or 2-hexyl-oct-1-yl; n-pentadecyl, particularly n-pentadec-1-yl or n-pentadec-2-yl, or mono-branched iso-pentadecyl, particularly 2-methyl-tetradec-1-yl, 13-methyl-tetradec-1-yl, 2-propyl-dodec-1-yl or 3-hexyl-non-1-yl; n-hexadecyl, particularly n-hexadec-1-yl or n-hexadec-2-yl, or mono-branched iso-hexadecyl, particularly 2-methyl-pentadec-1-yl, 14-methyl-pentadec-1-yl, 2-ethyl-tetradec-1-yl, 2-butyl-dodec-1-yl or 2-hexyl-dec-1-yl; n-heptadecyl, particularly n-heptadec-1-yl or n-heptadec-2-yl, or mono-branched iso-heptadecyl, particularly 2-methyl-hexadec-1-yl or 15-methyl-hexadec-1-yl; n-octadecyl, particularly n-octa-dec-1-yl or n-octadec-2-yl, or mono-branched iso-octadecyl, particularly 2-methyl-heptadec-1-yl or 16-methyl-heptadec-1-yl; n-nonadecyl, particularly n-nonadec-1-yl or n-nonadec-2-yl, or mono-branched iso-nonadecyl, particularly 2-methyl-octadec-1-yl or 17-methyl-octadec-1-yl; n-icosyl, particularly n-icos-1-yl or n-icos-2-yl, or mono-branched iso-icosyl, particularly 2-methyl-nonadec-1-yl or 1 8-methyl-nonadec-1-yl; or a mixture thereof.

A linear aliphatic C₁₀-C₂₀ alkenyl is for example is for example n-undec-10-en-1-yl, a C₁₈ alkenyl, particularly (9Z)-octadec-9-en-1-yl, (9E)-octadec-9-en-1-yl, (9Z, 12Z)-octadec-9,12-dien-1-yl or (9Z,12Z,15Z)-octadec-9,12,15-trien-1-yl, or a mixture thereof.

If R^{E} connects covalently to the oxygen atom in formula II via a carbon atom, which is covalently bound only to one other carbon atom in R^{E}, then R^{E}—OH is a primary alcohol (—CH₂—OH). If R^{E} connects covalently to the oxygen atom in formula II via a carbon atom, which is covalently bound to exactly two other carbon atoms in R^{E}, then R^{E}—OH is a secondary alcohol (—CH(OH)—).

R^{E} is preferably a linear or mono-branched aliphatic C₁₂-C₁₈ alkyl or a linear aliphatic C₁₈ alkenyl. More preferably, R^{E} is a linear aliphatic C₁₂-C₁₈ alkyl or a linear aliphatic C₁₈ alkenyl. Very preferably, R^{E} is a linear aliphatic C₁₂-C₁₈ alkyl, wherein R^{E} connects covalently to the oxygen atom in formula II via a carbon atom, which is covalently bound only to one other carbon atom in R^{E}, or a linear aliphatic C₁₈ alkenyl, wherein R^{E} connects covalently to the oxygen atom in formula II via a carbon atom, which is covalently bound only to one other carbon atom in R^{E}. Particularly, R^{E} is a linear aliphatic C₁₆-C₁₈ alkyl or a linear aliphatic C₁₈ alkenyl. More particularly, R^{E} is a linear aliphatic C₁₆-C₁₈ alkyl, wherein R^{E} connects covalently to the oxygen atom in formula II via a carbon atom, which is covalently bound only to one other carbon atom in R^{E}, or a linear aliphatic C₁₈ alkenyl, wherein R^{E} connects covalently to the oxygen atom in formula II via a carbon atom, which is covalently bound only to one other carbon atom in R^{E}. Very particularly, R^{E} is a linear aliphatic C₁₈ alkenyl. Especially, R^{E} is a linear aliphatic C₁₈ alkenyl, wherein R^{E} connects covalently to the oxygen atom in formula II via a carbon atom, which is covalently bound only to one other carbon atom in R^{E}. More especially, R^{E} is a linear aliphatic C₁₈ alkenyl with one carbon double bond. Very especially, R^{E} is a linear aliphatic C₁₈ alkenyl with one carbon double bond, wherein R^{E} connects covalently to the oxygen atom in formula II via a carbon atom, which is covalently bound only to one other carbon atom in R^{E}. Most especially, R^{E} is (9Z)-octadec-9-en-1-yl or (9E)-octadec-9-en-1-yl. Very especially, R^{E} is (9Z)-octadec-9-en-1-yl [=oleyl].

R^{E} is preferably a linear or mono-branched aliphatic unsubstituted C₁₂-C₁₈ alkyl or a linear aliphatic unsubstituted C₁₈ alkenyl. More preferably, R^{E} is a linear aliphatic unsubstituted C₁₂-C₁₈ alkyl or a linear aliphatic unsubstituted C₁₈ alkenyl. Very preferably, R^{E} is a linear aliphatic unsubstituted C₁₂-C₁₈ alkyl, wherein R^{E} connects covalently to the oxygen atom in formula II via a carbon atom, which is covalently bound only to one other carbon atom in R^{E}, or a linear aliphatic unsubstituted C₁₈ alkenyl, wherein R^{E} connects covalently to the oxygen atom in formula II via a carbon atom, which is covalently bound only to one other carbon atom in R^{E}. Particularly, R^{E} is a linear aliphatic unsubstituted C₁₆-C₁₈ alkyl or a linear aliphatic unsubstituted C₁₈ alkenyl. More particularly, R^{E} is a linear aliphatic unsubstituted C₁₆-C₁₈ alkyl, wherein R^{E} connects covalently to the oxygen atom in formula II via a carbon atom, which is covalently bound only to one other carbon atom in R^{E}, or a linear aliphatic unsubstituted C₁₈ alkenyl, wherein R^{E} connects covalently to the oxygen atom in formula II via a carbon atom, which is covalently bound only to one other carbon atom in R^{E}. Very particularly, R^{E} is a linear aliphatic unsubstituted C₁₈ alkenyl. Especially, R^{E} is a linear aliphatic unsubstituted C₁₈ alkenyl, wherein R^{E} connects covalently to the oxygen atom in formula II via a carbon atom, which is covalently bound only to one other carbon atom in R^{E}. More especially, R^{E} is a linear aliphatic unsubstituted C₁₈ alkenyl with one carbon double bond. Very especially, R^{E} is a linear aliphatic unsubstituted C₁₈ alkenyl with one carbon double bond, wherein R^{E} connects covalently to the oxygen atom in formula II via a carbon atom, which is covalently bound only to one other carbon atom in R^{E}.

Preferred is a method, wherein R^{E} is a linear or mono-branched aliphatic C₁₂-C₁₈ alkyl or a linear aliphatic C₁₈ alkenyl.

Preferred is a method, wherein R^{E} is linear.

n is for example 1, 2, 3, 4, 5, 6, 7, 8, 9, 10, 11 or 12. Preferably, n is 1, 2, 3, 4, 5, 6, 7, 8, 9 or 10. More preferably, n is 1, 2, 3, 4, 5, 6 or 7. Very preferably, n is 1, 2, 3, 4 or 5. Particularly, n is 1, 2, 3 or 4. More particularly, n is 2, 3 or 4. Most particularly, n is 2 or 3. Especially, n is 2.

Preferred is a method, wherein n is 1, 2, 3 or 4.

At the collector composition, the amidoamine can contain different compounds of formula I, i.e. two or more different compounds of formula I, or salts of the protonated different compounds of formula I and an anion. The different compounds of formula I can differ by a different substituent R¹. The different compounds of formula I can differ by different substituents R², R³ or R⁴ . Preferably, the different compounds of formula I differ by different substituents R¹. More preferably, the different compounds of formula I differ by different substituents R¹ and one of the different substituents R¹ is a linear C₁₇ alkenyl. Very preferably, one of the different substituents R¹ is a linear C₁₇ alkenyl and one of the different substituents R¹ is a linear pentadecyl. Particularly, one of the different substituents R¹ is (8Z)-heptadec-8-enyl and one of the different substituents R¹ is n-pentadec-1-yl. More particularly, one of the different substituents (8Z)-heptadec-8-en-1-yl, one of the different substituents R¹ is a n-pentadec-1-yl and one of the different substituents R¹ is (8Z,11Z)-heptadec-8,11-dienyl.

At the collector composition, the ethoxylate can contain different compounds of formula II, i.e. two or more different compounds of formula II. The different compounds of formula II can differ by a different n. The different compounds of formula II can differ by a different R^{E}. Preferably, the different compounds of formula II differ by a different n. More preferably, the different compounds of formula II differ by a different n and one of the different n is 2 and one of the different n is 3. Preferably, the different compounds of formula II differ by a different R^{E}. More preferably, the different compounds of formula II differ by a different R^{E} and one of the different R^{E} is a linear or mono-branched aliphatic C₁₃ alkyl or one of the different R^{E} is (9Z)-octadec-9-en-1-yl. Very preferably, the different compounds of formula II differ by a different R^{E} and one of the different R^{E} is a linear or mono-branched aliphatic C₁₃ alkyl and one of the different R^{E} is a linear or mono-branched aliphatic Cis alkyl or one of the different R^{E} is (9Z)-octadec-9-en-1-yl and one of the different R^{E} is n-hexadec-1-yl. Particularly, the different compounds of formula II differ by a different R^{E} and one of the different R^{E} is a linear aliphatic C₁₃ alkyl and one of the different R^{E} is a linear aliphatic Cis alkyl or one of the different R^{E} is (9Z)-octadec-9-en-1-yl and one of the different R^{E} is n-hexadec-1-yl. More particularly, the different compounds of formula II differ by a different R^{E} and one of the different R^{E} is (9Z)-octadec-9-en-1-yl and one of the different R^{E} is n-hexadec-1-yl. Very particularly, the different compounds of formula II differ by a different R^{E} and one of the different R^{E} is (9Z)-octadec-9-en-1-yl, one of the different R^{E} is n-hexadec-1-yl and the overall amount of molecules of compounds of formula II with R^{E}=(9Z)-octadec-9-en-1-yl is higher than the overall amount of molecules of formula II with R^{E}=n-hexa-dec-1-yl.

An average degree of branching of R^{E} is herein defined as the number of all mono-branched R^{E} divided by sum of the number of all mono-branched R^{E} and the number of all linear R^{E}. The value of an average degree of branching is between 0 in case all R^{E} are linear and 1 in case of all R^{E} are mono-branched. In case, all R^{E} are the same, the average degree of branching of R^{E} is 0 or 1. In case of two or more different R^{E}, the average degree of branching is between 0 and 1. Preferably, the average degree of branching of R^{E} is between 0 and 0.8. More preferably, the average degree of branching of R^{E} is between 0 and 0.7. Very preferably, the average degree of branching of R^{E} is between 0 and 0.65. It is understood that a degree of branching of a moiety is generally, i.e. not limited to R^{E}, defined as follows: An average degree of branching of a moiety, e.g. an alkyl or an alkylene, is herein defined as the adjusted number of all branched moieties divided by the sum of the number of all branched moieties and the number of all linear moieties. The number of all branched moieties is adjusted by counting mono-branched moieties once, double-branched moieties twice, triple-branched moieties three-times etc. Whether a moiety is mono-branched, double-branched, triple-branched etc. is calculated for a moiety by counting a carbon atom connected covalently to 3 other carbon atoms with 1 and a carbon atom connected covalently to 4 other carbon atoms with 2. For example, a 2-methyl-dodec-1yl is mono-branched, a 2,4-dimethyl-undec-1-yl is double-branched, a 10,10-dimethyl-undecy-1-yl is double-branched and a 2,9,9-trimethyl-dec-1-yl is triple-branched. The value of an average degree of branching is between 0 in case all moieties are linear and 1 in case of all moieties are mono-branched. In case, all moieties are the same, the average degree of branching of a moiety is an integer. In case of two or more different moieties, the average degree of branching is between 0 and an upper limit. The upper limit goes until the maximum integer possible for a given number of carbon atoms.

Preferred is a method, wherein in case the ethoxylate contains only compounds of formula II with the same R^{E}, the same R^{E} is linear, or in case the ethoxylate contains compounds of formula II with two or more different R^{E}, an average degree of branching of R^{E} for all the compounds of formula II is between 0 and 0.8.

Preferred is a method, wherein
(i) the amidoamine contains different compounds of formula I, or salts of the protonated different compounds of formula I and an anion;
(ii) the ethoxylate contains different compounds of formula II.

The amidoamine containing a compound of formula I is preferably obtainable by condensation of a fatty acid of formula I-FA with an amine of formula I-A

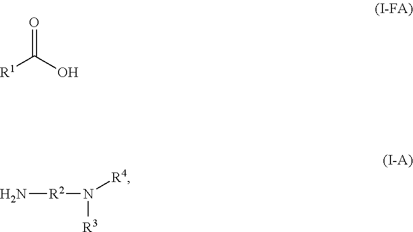

wherein R¹, R², R³, R⁴ and formula I-S, p, q and * are defined as above. Condensation means in case of a fatty acid and an amine a removal of water, typically by heating the fatty acid and the amine at an elevated temperature and removal of water by distillation. Preferably, one mol of a fatty acid of formula I-FA is condensed with 0.8 to 1.5 mol of an amine of formula I-A. More preferably, one mol of a fatty acid of formula I-FA is condensed with 0.9 to 1.4 mol of an amine of formula I-A. Very preferably, one mol of a fatty acid of formula I-FA is condensed with 1 to 1.3 mol of an amine of formula I-A. In other words, there is very preferably one mol of a fatty acid of formula I-FA condensed with equimolar amounts or up to 0.3 mol excess of an amine of formula I-A. Preferably, the fatty acid of formula I-FA is from a natural source, which is a natural fat or an oil of plant or animal origin. More preferably, the fatty acid of formula I-FA is obtainable by hydrolysis of a glyceride, which originates from a natural source from a natural source, which is a natural fat or an oil of plant or animal origin.

It is assumed that in case of a suitable amine of formula I-A, an intramolecular condensation reaction can occur and leads to an equilibrium of an amidoamine of formula I and an intramolecularly cyclized molecule. A suitable amine of formula I-FA has a R², which is a C₂-C₃ alkylene and at least one of R³ and R⁴ are H. This allows with R² being a C₂ alkylene a formation of a five-membered ring, which is a dihydroimidazol derivative. This allows with R³ being a C₃ alkylene a formation of a six-membered ring, which is a tetrahydropyrimidine derivative.

For example, a condensation product of N′,N′-dimethylpropane-1,3-diamine with rapeseed-oil is known under CAS-No. 85408-42-0. A condensation product of N′,N′-dimethylpropane-1,3-diamine with tall oil is known under CAS-No. 68650-79-3. A condensation product of N′,N′-dimethylpropane-1,3-diamine with fish oil is known under CAS-No. 97552-95-9. A condensation product of N′,N′-dimethylpropane-1,3-diamine (alternative name: 3-(dimethylamino)propylamine) with soy oil is known under CAS-No. 68188-30-7 and named in CAS registry as amides, soy, N-[3-(dimethylamino)propyl. Soy oil possesses distribution ranges of individual fatty acids, which is described in one literature for example as containing as major components around 8 to 14 mol % palmitic acid, around 1 to 6 mol % stearic acid, around 17 to 30 mol % oleic acid, around 48 to 59 mol % linoleic acid and around 4 to 11 mol % linolenic acid—all based on the overall molar amount of fatty acids, which is 100 mol %. It is also to be noted that soy oil is a natural product and the composition may slightly vary depending on the growth conditions and breed of the soy plant. For example, a specific distribution of major components of soy oil fatty acids is described in the mentioned literature as around 10 mol % palmitic acid, around 5 mol % stearic acid, around 21 mol % oleic acid, around 53 mol % linoleic acid and around 8 mol % linolenic acid—based on the overall molar amount of fatty acids, which is 100 mol %. The meaning of around in the two previous sentences refers also to the slight differences if one considers wt. % versus mol %. The molecular weight of the major components is not the same but also not too much different, hence in a first approximation, wt. % can be taken as mol % and vice versa. Soy oil fatty acids can be distilled, which might lead to changes versus the fatty acid distribution before distillation. The amidoamine obtained from a condensation of N′,N′-dimethylpropane-1,3-diamine with palmitic acid is known under CAS-No. 39669-97-1, a chloride salt of the protonated amidoamine under CAS-No. 151190-60-2, a palmitate salt of the protonated amidoamine under CAS-No. 220820-88-2, an acetate salt of the protonated amidoamine under CAS-No. 83763-68-2. The amidoamine product obtained from a condensation of N′,N′-dimethylpropane-1,3-diamine with stearic acid is known under CAS-No. 7651-02-7, a chloride salt of the protonated amidoamine under CAS-No. 83607-13-0, a stearate acid salt of the protonated amidoamine under CAS-No. 127358-77-4, an acetate salt of the protonated amidoamine under CAS-No. 13282-70-7. The amidoamine product obtained from a condensation of N′,N′-dimethylpropane-1,3-diamine with oleic acid is known under CAS-No. 109-28-4, a bromide salt of the protonated amidoamine under CAS-No. 76959-11-0, an oleate salt of the protonated amidoamine under CAS-No. 70715-14-9, an acetate salt of the protonated amidoamine under CAS-No. 13282-68-3, a sulfate salt with two of the mono-protonated amidoamines under CAS-No. 1638206-65-1. The amidoamine product obtained from a condensation of N′,N′-dimethylpropane-1,3-diamine with linoleic acid is known under CAS-No. 81613-56-1, a linoleate salt of the protonated amidoamine under CAS-No. 651294-42-7, a 2-hydroxypropionate salt of the protonated amidoamine under CAS-No. 187939-51-1. The amidoamine product obtained from a condensation of N′,N′-dimethylpropane-1,3-diamine with linolenic acid is known under CAS-No. 122955-03-7.

Preferred is a method, wherein
(i) the amidoamine is obtainable by condensation of a fatty acid of formula I-FA with an amine of formula I-A

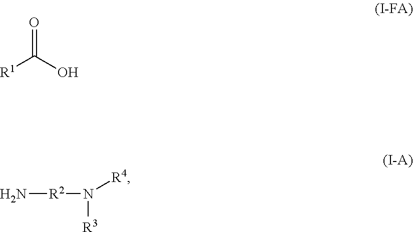

wherein R¹, R², R³, R⁴ and formula I-S, p, q and * are defined as in claim 1.

The ethoxylate containing a compound of formula II is preferably obtainable by ethoxylation of one equivalent of an alcohol of formula II-AL

R^{E}—OH (II-AL),

wherein R^{E} is defined as above, with n equivalents of ethylene oxide, wherein n is defined as above. The ethoxylation the alcohol of formula II-AL can be conducted by well-known procedures. The respective alcohol is typically reacted with ethylene oxide in the presence of a suitable catalyst, for example a conventional basic catalyst such as potassium hydroxide. Preferably, the alkoxylation is conducted with a basic catalyst, more preferably with an alkali hydroxide, very preferably with potassium hydroxide or sodium hydroxide and particularly with potassium hydroxide.

Linear primary alcohols are obtainable from a natural source, which is a natural fat or an oil of plant or animal origin, by hydrogenation (=a linear primary alcohol from a natural source). Secondary linear alcohols are obtainable by a Bashkirov oxidation of a linear alkane (=a secondary linear alcohol from a Bashkirov oxidation). Linear or mono-branched primary alcohols are obtainable by a hydroformylation reaction via adding carbon monoxide and hydrogen to a linear mono-olefin with the double bond at an end of the linear alkylene chain to obtain an aldehyde and followed by hydrogenation of the aldehyde to obtain the oxo-alcohols. By an introduction of the carbonyl moiety at the 1-position of the linear mono-olefin, a finally linear primary alcohol is obtained. By an introduction of the carbonyl moiety at the 2-position of the linear mono-olefin, a finally mono-branched alcohol with one methyl group at the 2-position of the mono-branched primary alcohol is obtained (=a linear or mono-branched oxo-alcohol). Branched primary alcohols are obtainable by a hydroformylation reaction via adding carbon monoxide and hydrogen to a branched mono-olefin with the double bond at an end of the branched alkylene chain to obtain an aldehyde and followed by hydrogenation of the aldehyde to obtain the oxo-alcohols. By an introduction of the carbonyl moiety at the 1-position of the branched mono-olefin, a finally branched primary alcohol is obtained. The degree of branching remains the same (=a branched oxo-alcohol). By an introduction of the carbonyl moiety at the 2-position of the branched monoolefin, a branched alcohol with one methyl group at the 2-position of the branched primary alcohol is obtained. The degree of branching is increased by one (=a branched oxo-alcohol). If the branched mono-olefin is itself double-branched, then the branched oxo-alcohol contains doublebranched and triple-branched primary alcohols. Mono-branched primary alcohols are obtainable by a Guerbet reaction, i.e. converting a primary linear starting alcohol into its beta-alkylated dimer alcohol with loss of one equivalent of water (=a mono-branched primary Guerbet alcohol). Preferably, the alcohol of formula II-AL is a primary linear alcohol from a natural source, a secondary linear alcohol from a Bashkirov oxidation, a linear or mono-branched primary oxo-alcohol or a mono-branched primary Guerbet alcohol. More preferably, the alcohol of formula II-AL is a primary linear alcohol from a natural source, a secondary linear alcohol from a Bashkirov oxidation or a linear or mono-branched primary oxo-alcohol. Very preferably, the alcohol of formula II-AL is a primary linear alcohol from a natural source or a linear or mono-branched primary oxo-alcohol. Very preferably, the alcohol of formula II-AL is a primary linear alcohol from a natural source or a secondary linear alcohol from a Bashkirov oxidation. Particularly, the alcohol of formula II-AL is a primary linear alcohol from a natural source.

Preferred is a method, wherein
(ii) the ethoxylate is obtainable by ethoxylation of one equivalent of an alcohol of the formula II-AL

R^{E}—OH (II-AL),
wherein R^{E} is defined as above, with n equivalents of ethylene oxide,
wherein n is defined as above.

Preferred is a method, wherein the collector composition comprises
(i) an amidoamine, which contains a compound of formula I

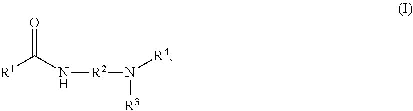

wherein
R¹ is a linear or branched aliphatic C₁₁-C₁₉ alkyl or a linear C₁₁-C₁₉ aliphatic alkenyl,
R² is a linear or branched aliphatic C₂-C₆ alkylene,
R³ and R⁴ are independently from each other H, C₁-C₂ alkyl or a substituent of formula I-S

*-[—(CH₂—)ₚ—NH—]_{q}—(—CH₂—)ₚ—NH₂ (I-S)
wherein
p is 2, 3 or 4,
q is 0, 1, 2 or 3, and
* represents the connecting site of the substituent, or

a salt of a protonated compound of formula I and an anion, and which is obtainable by condensation of a fatty acid of formula I-FA with an amine of formula I-A

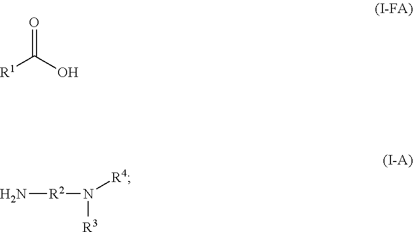

(ii) an ethoxylate, which contains a compound of formula II

R^{E}—O—(—CH₂—CH₂—O—)ₙ—H (II)
wherein
R^{E} is a linear or mono-branched aliphatic C₁₀-C₂₀ alkyl or a linear aliphatic C₁₀-C₂₀ alkenyl,
n is an integer from 1 to 12, and
which is obtainable by ethoxylation of one equivalent of an alcohol of formula II-AL

R^{E}—OH (II-AL)
with n equivalents of ethylene oxide.

The collector composition used in the method according to the present invention comprises more parts per weight of (i) the amidoamine than of (ii) the ethoxylate.

This means that collector composition used in the method according to the present invention comprises more than 50 parts by weight of (i) the amidoamine and less than 50 parts by weight of (ii) the ethoxylate.

The collector composition used in the method according to the present invention comprises significantly more parts per weight of (i) the amidoamine than of (ii) the ethoxylate. “Significantly more” means that collector composition used in the method according to the present invention comprises more than 60 parts by weight of (i) the amidoamine and less than 40 parts by weight of (ii) the ethoxylate.

Preferably, the collector composition comprises (i) 65 to 99 parts by weight of the amidoamine, (ii) 1 to 35 parts by weight of the ethoxylate, and the sum of the amidoamine and the ethoxylate is 100 parts by weight. More preferably, the collector composition comprises (i) 75 to 99 parts by weight of the amidoamine, (ii) 1 to 25 parts by weight of the ethoxylate, and the sum of the amidoamine and the ethoxylate is 100 parts by weight. Very preferably, the collector composition comprises (i) 85 to 99 parts by weight of the amidoamine, (ii) 1 to 15 parts by weight of the ethoxylate, and the sum of the amidoamine and the ethoxylate is 100 parts by weight. Particularly, the collector composition comprises (i) 88 to 99 parts by weight of the amidoamine, (ii) 1 to 12 parts by weight of the ethoxylate, and the sum of the amidoamine and the ethoxylate is 100 parts by weight. More particularly, the collector composition comprises (i) 89 to 98.8 parts by weight of the amidoamine, (ii) 1.2 to 11 parts by weight of the ethoxylate, and the sum of the amidoamine and the ethoxylate is 100 parts by weight. Very particularly, the collector composition comprises (i) 89.5 to 98.6 parts by weight of the amidoamine, (ii) 1.4 to 10.5 parts by weight of the ethoxylate, and the sum of the amidoamine and the ethoxylate is 100 parts by weight. Especially, the collector composition comprises (i) 89.8 to 98.4 parts by weight of the amidoamine, (ii) 1.6 to 10.2 parts by weight of the ethoxylate, and the sum of the amidoamine and the ethoxylate is 100 parts by weight. More especially, the collector composition comprises (i) 89.9 to 98.2 parts by weight of the amidoamine, (ii) 1.8 to 10.1 parts by weight of the ethoxylate, and the sum of the amidoamine and the ethoxylate is 100 parts by weight. Very especially, R^{E} is a linear aliphatic C₁₀-C₂₀ alkenyl and the collector composition comprises (i) 95 to 99 parts by weight of the amidoamine, (ii) 1 to 5 parts by weight of the ethoxylate, and the sum of the amidoamine and the ethoxylate is 100 parts by weight. Most especially, R^{E} is a linear aliphatic C₁₀-C₂₀ alkenyl and the collector composition comprises (i) 96 to 99 parts by weight of the amidoamine, (ii) 1 to 4 parts by weight of the ethoxylate, and the sum of the amidoamine and the ethoxylate is 100 parts by weight.

Hence, in the method according to the present invention the collector composition applied comprises more parts per weight of (i) the amidoamine than of (ii) the ethoxylate.

This means that collector composition comprises more than 50 parts by weight of (i) the amidoamine and less than 50 parts by weight of (ii) the ethoxylate.

In the method according to the present invention the collector composition applied comprises significantly more parts per weight of (i) the amidoamine than of (ii) the ethoxylate. “Significantly more” means that collector composition used in the method according to the present invention comprises more than 60 parts by weight of (i) the amidoamine and less than 40 parts by weight of (ii) the ethoxylate.

Preferred is a method, wherein the collector composition comprises
(i) 65 to 99 parts by weight of the amidoamine, and
(ii) 1 to 35 parts by weight of the ethoxylate,
   and the sum of the amidoamine and the ethoxylate is 100 parts by weight.

More preferred is a method, wherein the collector composition comprises
(i) 75 to 99 parts by weight of the amidoamine, and
(ii) 1 to 25 parts by weight of the ethoxylate,
   and the sum of the amidoamine and the ethoxylate is 100 parts by weight.

Particularly preferred is a method, wherein the collector composition comprises
(i) 85 to 99 parts by weight of the amidoamine, and
(ii) 1 to 15 parts by weight of the ethoxylate,
   and the sum of the amidoamine and the ethoxylate is 100 parts by weight.

Preferably, the collector composition consists out of (i) the amidoamine and (ii) the ethoxylate. More preferably, the collector composition consists out of (i) 65 to 99 parts by weight of the amidoamine, (ii) 1 to 35 parts by weight of the ethoxylate, and the sum of the amidoamine and the ethoxylate is 100 parts by weight. Very preferably, the collector composition consists out of (i) 75 to 99 parts by weight of the amidoamine, (ii) 1 to 25 parts by weight of the ethoxylate, and the sum of the amidoamine and the ethoxylate is 100 parts by weight. Particularly, the collector composition consists out of (i) 85 to 99 parts by weight of the amidoamine, (ii) 1 to 15 parts by weight of the ethoxylate, and the sum of the amidoamine and the ethoxylate is 100 parts by weight. More particularly, the collector composition consists out of (i) 88 to 99 parts by weight of the amidoamine, (ii) 1 to 12 parts by weight of the ethoxylate, and the sum of the amidoamine and the ethoxylate is 100 parts by weight. Very particularly, the collector composition comprises (i) 89 to 98.8 parts by weight of the amidoamine, (ii) 1.2 to 11 parts by weight of the ethoxylate, and the sum of the amidoamine and the ethoxylate is 100 parts by weight. Especially, the collector composition consists out of (i) 89.5 to 98.6 parts by weight of the amidoamine, (ii) 1.4 to 10.5 parts by weight of the ethoxylate, and the sum of the amidoamine and the ethoxylate is 100 parts by weight. More especially, the collector composition consists out of (i) 89.8 to 98.4 parts by weight of the amidoamine, (ii) 1.6 to 10.2 parts by weight of the ethoxylate, and the sum of the amidoamine and the ethoxylate is 100 parts by weight. Very especially, the collector composition consists out of (i) 89.9 to 98.2 parts by weight of the amidoamine, (ii) 1.8 to 10.1 parts by weight of the ethoxylate, and the sum of the amidoamine and the ethoxylate is 100 parts by weight. Most especially, R^{E} is a linear aliphatic C₁₀-C₂₀ alkenyl and the collector composition consists out of (i) 95 to 99 parts by weight of the amidoamine, (ii) 1 to 5 parts by weight of the ethoxylate, and the sum of the amidoamine and the ethoxylate is 100 parts by weight.

The collector composition is added preferably as an aqueous solution or suspension. The aqueous solution or suspension of the collector composition is for example obtained by dissolving the amidoamine and the ethoxylate in water under stirring. Dissolving is conducted at room temperature or at a temperature above room temperature but below the boiling point of water. The aqueous solution or suspension of the collector composition contains the collector composition and water. The aqueous solution or suspension of the collector composition contains preferably 0.3 to 80 wt. % of the collector composition based on the weight of the aqueous solution or suspension of the collector composition and water. More preferably, the aqueous solution or suspension of the collector composition contains 0.5 to 60 wt. % of the collector composition based on the weight of the aqueous solution or suspension of the collector composition and water. Very preferably, the aqueous solution or suspension of the collector composition contains 0.6 to 40 wt. % of the collector composition based on the weight of the aqueous solution or suspension of the collector composition and water. Particularly, the aqueous solution or suspension of the collector composition contains 0.7 to 30 wt. % of the collector composition based on the weight of the aqueous solution or suspension and water. More particularly, the aqueous solution or suspension of the collector composition contains 0.8 to 20 wt. % of the collector composition based on the weight of the aqueous solution or suspension and water. Very particularly, the aqueous solution or suspension of the collector composition contains 0.9 to 10 wt. % of the collector composition based on the weight of the aqueous solution or suspension and water.

Preferred is a method, wherein the collector composition is added as an aqueous solution or suspension.

The collector composition is added preferably in an amount of 10 g to 500 g per ton of the ore. The calculation is performed on basis of dry ore. The amount is more preferably from 30 g to 300 g per ton of the ore, very preferably from 40 g to 250 g per ton of the ore, particularly from 60 g to 220 g per ton of the ore, more particularly from 70 g to 180 g per ton of the ore, very particularly from 80 g to 160 g per ton of the ore and especially from 90 g to 140 g per ton of the ore.

Preferred is a method, wherein the collector composition is added in an amount between 10 g to 500 g per ton of the ore.

The pH value at the steps (c) and (d) of the method is preferably adjusted with a pH regulator to a specific pH value, typically to a pH value between 8 and 12, particularly between 9 and 11. A pH regulator is typically a strong base, for example sodium hydroxide, potassium hydroxide, sodium carbonate or potassium carbonate. Preferably, the pH value of the aqueous pulp is between 8 and 12, particularly between 9 and 11. Preferably, step (c), i.e. adding the collector composition to the aqueous pulp, takes place at a pH value between 8 and 12, particularly between 9 and 11. Preferably, the pH value of the aqueous mixture is between 8 and 12, particularly between 9 and 11. Preferably, step (d), i.e. aerating the aqueous mixture, takes place at a pH value between 8 and 12, particularly between 9 and 11. Preferably, (e), i.e. obtaining the concentrate enriched in iron mineral content, takes place at a pH value between 8 and 12, particularly between 9 and 11. A regulation of the pH value supports that the ore, especially the particles of the ore, exhibit the correct surface charge.

Preferred is a method, wherein the pH value at step (c) is between 8 and 12.

Preferred is a method, wherein the pH value at step (c) and at step (b) is between 8 and 12.

Preferred is a method, wherein the pH value at step (c) and at step (d) is between 8 and 12.

Preferred is a method, wherein the pH value at step (c), at step (b) and at step (d) is between 8 and 12.

Preferred is a method, wherein the pH value at step (c), at step (b), at step (d) and at step (e) is between 8 and 12.

A flotation auxiliary is different to (i) an amidoamine and (ii) an ethoxylate and for example a depressing agent, a froth regulator, a co-collector or an extender oil.

A depressing agent helps to prevent flotation of an ingredient of the ore, which is not desired to get part of the froth or supports in general the selectivity of the method of manufacturing the concentrate. A depressing agent is for example a hydrophilic polysaccharide, particularly a starch, or sodium silicate. The starch is for example a native starch or a modified starch. A native starch is for example a starch from corn, wheat, oat, barley, rice, millet, potato, pea, tapioca or manioc. The native starch is preferably pregelatinized, i.e. warmed for starch gelation in an aqueous solution, or caustified, i.e. treated with a strong base, for example NaOH, KOH or Ca(OH)₂, in an aqueous solution. A modified starch is either a degraded starch, which possesses a reduced weight-average molecular weight versus the original starch, a chemically modified starch or a degraded and chemically modified starch. A degradation of starch is for example possible by oxidation or treatment by acid, base or enzymes. The degradation leads typically to an increased content on oligosaccharides or dextrines. A chemical modification is a functionalization of a starch by covalent linkage of a chemical group to the starch. A chemically modified starch is for example obtainable by esterification or etherification of a starch. The esterification of an acid with a starch is for example performed with an anhydride of the acid or a chloride of the acid. The etherification of a starch is for example possible with an organic reagent, which contains a reactive epoxide functionality. Preferred is a depressing agent, which is a starch, very preferably a native starch, particularly a pregelatinized starch or a caustified starch, especially a caustified starch. A depressing agent is preferably added in an amount of 100 to 3000 g per ton of the ore. The calculation is performed on basis of dry ore. The amount is more preferably from 200 g to 2000 g per ton of the ore, very preferably from 300 g to 1200 g per ton of the ore, particularly from 400 g to 900 g per ton of the ore and more particularly from 450 g to 600 g per ton of the ore.

A froth regulator helps to improve the efficiency of the method of manufacturing by interfering with the froth generation. A froth property is for example the froth height respectively the volume of the froth or the stability of the froth, i.e. the time to collapse after stop of aerating. A froth regulator is for example pine oil, terpineol, methylisobutyl carbinol, C₆-C₉ alcohol, particularly 2-ethylhexanol or hexanol, an alcoholic ester, particularly a mixture comprising 2,2,4-tri-methyl-1,3-pentandiolmonoisobutyrate, a distillation residue from an oxo-synthesis of 2-ethylhexanol, triethoxybutane, an alkoxylated C₁-C₆ alcohol, particularly an ethoxylated and/or propoxylated C₁-C₆ alcohol, polyethylene glycol or polypropylene glycol. It is still attractive, if the method does not require the addition of a froth regulator. Preferably, the method is free of using a froth regulator.

A co-collector is a surface-active compound, which is different to an amidoamine and an ethoxylate. A co-collector is for example cationic, non-ionic or anionic, preferably cationic or non-ionic and very preferably cationic. A cationic co-collector is for example C₉-C₁₈ alkylamine, 2-(C₉-C₁₈ alkyl-amino)ethyl-1-amine, N′-(C₉-C₁₈ alkyl)propane-1,3-diamine, 3-(C₉-C₁₈ alkoxy)propyl-1-amine, N′-(3-(C₉-C₁₈ alkoxy)propyl)propane-1,3-diamine. An anionic co-collector is for example a C₈-C₁₈ alkyl sulfate, particularly sodium lauryl sulfate, a C₆-C₁₀ alkyl sulfosuccinate monoester or a C₈-C₂₀ fatty acid. A non-ionic co-collector is for example C₉-C₁₅ alkyl alcohol, which is branched. In case of a co-collector as a flotation auxiliary, the co-collector might be added together with the collector composition. In this case, this part of step (b) occurs simultaneously with step (c).

It is still attractive, if the method does not require the addition of a co-collector.

Preferred is a method, wherein an amine of formula R²—NH₂, wherein R² is a C₁-C₂₄ alkyl, a phenyl, a benzyl, a C₁-C₂₄ alkenyl, a heterocyclyl, an unsubstituted aryl or an aryl substituted by one or more C₁-C₈ alkyl substituents, is contained in a weight ratio below 1 to 100 with 100 being the weight amount of all compounds of formula I. Very preferred, the method is free of adding an amine of formula R²—NH₂. Particularly preferred, the method is free of adding an amine of formula R²—NH₂ or a salt of a protonated amine of formula R²—NH₂ and an anion.

Preferred is a method, wherein an etheramine is contained in a weight ratio below 20 to 100 with 100 being the weight amount of all compounds of formula I. Very preferred is a method, wherein an etheramine is contained in a weight ratio below 1 to 100 with 100 being the weight amount of all compounds of formula I. Particularly preferred, the method is free of adding an etheramine. Especially preferred, the method is free of adding an etheramine or a salt of a protonated etheramine and an anion. An etheramine is herein understood as a molecule, which comprises the structural element alkyl-O-alkylene-NH— . . . , for example molecules described by alkyl-O-al-kylene—NH₂ or alkyl-O-alkylene-NH-alkylene—NH₂.

An extender oil is for example kerosene, diesel or a methyl or ethyl ester of a C₁₂-C₂₀ fatty acid.

Preferred is a method, wherein at step (b) one or more flotation auxiliaries are added and one of the flotation auxiliaries is a depressing agent, a froth regulator, a co-collector or an extender oil.

Preferred is a method, wherein one of the flotation auxiliaries added at step (b) is a depressing agent.

Preferred is a method, wherein a depressing agent, which is starch, is added.

Preferred is a method, wherein one of the flotation auxiliaries added at step (b) is a depressing agent and one of the flotation auxiliaries is a co-collector, which is added at step (b) before step (c) or is added simultaneously with the collector composition.

Addition of corn starch, typically foreseen as a depressing agent, is often common practice. Preferably, the method is free of adding a pregelatinized corn starch, very preferably free of adding a corn starch, particularly free of adding a starch and very particularly free of adding a hydrophilic polysaccharide.

In the method of manufacturing a concentrate, conventional inverse flotation plant equipment may be used. Preferably, the collector composition and optionally a flotation auxiliary, which is a co-collector, is or are added to the aqueous pulp, which is already in the flotation cell, which is used for aerating the mixture in step (d).

After adding of a collector composition to the aqueous pulp, the obtained aqueous mixture is preferably kept, particularly under stirring, for a conditioning period before aerating the aqueous mixture. This allows the collector composition and optionally a flotation auxiliary, which is a co-collector, to condition the ore, particularly the ore particles, in the aqueous mixture. The conditioning period lasts for example for one minute or up to 10 or 15 minutes.

At aerating the aqueous mixture, air is typically injected into the base of the flotation cell. Air bubbles are formed and rise to the surface and generate the froth at the surface. The injection of air may be continued until no more froth is formed. This might last for example for one minute or up to 15 or 20 minutes. The froth is removed.

For obtaining the concentrate enriched in iron mineral content, aerating is typically stopped. The concentrate enriched in iron mineral content sinks typically to the bottom of the flotation cell.

In some cases, it may be desirable to treat the concentrate enriched in iron mineral content in a similar manner again. For example, the steps (c) and (d) are repeated as step (d-c) followed by step (d-d) before step (e) is conducted.

The concentrate enriched in iron mineral content contains preferably at least 60 wt. % Fe atoms based on the overall weight of the concentrate enriched in iron mineral content, very preferably at least 65 wt. %. The weight of Fe atoms is similar to the weight of iron content. The concentrate enriched in iron mineral content contains preferably less than 2.5 wt. % of SiO₂ based on the overall weight of the concentrate enriched in iron mineral, more preferably less than 2.1 wt. %, very preferably 2.0 wt. % and particularly less than 1.9 wt. % by weight of SiO₂. The concentrate enriched in iron mineral content contains preferably at least 60 wt. % of Fe atoms and less than 2.5 wt. % of SiO₂ based on the overall weight of the concentrate enriched in iron mineral content, very preferably at least 65 wt. % of Fe atoms and less than 2.1 wt. %.

The above described preferences for the method of manufacturing a concentrate or for the added collector composition are described for the method. These preferences apply also to the further embodiments of the invention.

A further embodiment of the invention is a use of a collector composition comprising
(i) an amidoamine, which contains a compound of formula I

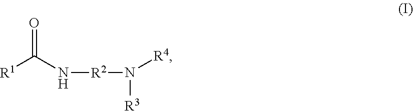

wherein
R¹ is a linear or branched aliphatic C₇-C₁₉ alkyl or a linear C₇-C₁₉ aliphatic alkenyl,
R² is a linear or branched aliphatic C₂-C₆ alkylene,
R³ and R⁴ are independently from each other H, C₁-C₂ alkyl or a substituent of formula I-S

*-[—(CH₂—)ₚ—NH—]_{q}—(—CH₂—)ₚ—NH₂ (I-S),
wherein
p is 2, 3 or 4,
q is 0, 1, 2 or 3, and
* represents the connecting site of the substituent, or
a salt of a protonated compound of formula I and an anion;
(ii) an ethoxylate, which contains a compound of formula II

R^{E}—O—(—CH₂—CH₂—O—)ₙ—H (II),
wherein
R^{E} is a linear or mono-branched aliphatic C₁₀-C₂₀ alkyl or a linear aliphatic C₁₀-C₂₀ alkenyl,
n is an integer from 1 to 12,
   as a flotation collector for manufacturing a concentrate enriched in iron mineral content from an ore, which contains an iron mineral and silicate, by a reverse flotation.

A further embodiment of the invention is a collector composition comprising
(i) an amidoamine, which contains a compound of formula I

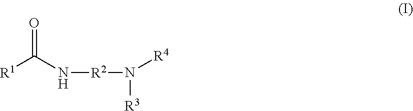

wherein
R¹ is a linear or branched aliphatic C₇-C₁₉ alkyl or a linear C₇-C₁₉ aliphatic alkenyl,
R² is a linear or branched aliphatic C₂-C₆ alkylene,
R³ and R⁴ are independently from each other H, C₁-C₂ alkyl or a substituent of formula I-S

*-[—(CH₂—)ₚ—NH—]_{q}—(—CH₂—)ₚ—NH₂ (I-S),
wherein
p is 2, 3 or 4,
q is 0, 1, 2 or 3, and
* represents the connecting site of the substituent, or
a salt of a protonated compound of formula I and an anion;
(ii) an ethoxylate, which contains a compound of formula II

R^{E}—O—(—CH₂—CH₂—O—)ₙ—H (II)
wherein
R^{E} is a linear or mono-branched aliphatic C₁₀-C₂₀ alkyl or a linear aliphatic C₁₀-C₂₀ alkenyl, and
n is an integer from 1 to 12.

Preferably, the collector composition is part of an aqueous solution or suspension, which contains the collector composition and water.

The following examples illustrate further the invention without limiting it. Percentage values are percentage by weight if not stated differently.

A) amidoamine Collector

SOFA-1 is a distilled soy oil fatty acid grade with a specification of ≤0.1 wt. % saturated C₁₄ carboxylic acid (e.g. tetradecanoic acid), 10-23 wt. % saturated C₁₆ carboxylic acid (e.g. palmitic acid), 2-8 wt. % saturated C₁₈ carboxylic acid (e.g. stearic acid), 24-34 wt. % mono-unsaturated C₁₈ carboxylic acid (e.g. oleic acid), 38-50 wt. % di-unsaturated C₁₈ carboxylic acid (e.g. linoleic acid) and 2-8 wt. % tri-unsaturated C₁₈ carboxylic acid (e.g. linolenic acid).

A-1: Reaction Product of Soy Oil Fatty Acid and N,N-dimethylpropane-1,3-diamine (101)

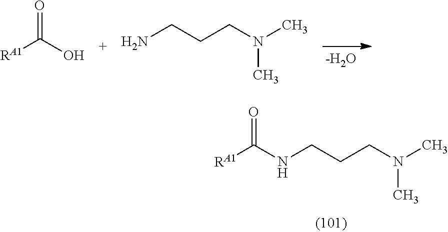

A stirred solution of distilled soy oil fatty acid (410 g SOFA-1, 1.5 mol, represented by R^{A1}—C(═O)OH in the reaction scheme) is heated to 40° C. and N′,N′-dimethylpropane-1,3-diamine (199 g, 1.95 mol; molar ratio of R^{A1}—C(═O)OH to N,N-dimethylpropane-1,3-diamine is 1 to 1.3) is added in 5 minutes. The addition causes an exothermic reaction due to a salt formation. After complete addition, the reaction mixture is quickly heated until 80° C. and then heated slowly until 150° C. in 1.5 hours. The mixture is kept at reflux at 150° C. for 1 hour. Afterwards, water is distilled. Then, the reaction temperature is slowly raised until 180° C. and is kept at this temperature for one hour. The acidic index is measured by titration with KOH solution (0.05 mol/L) to identify the end of the reaction by using 50 mL neutralized ethanol as solvent and phenolphthalein as indicator. After all the fatty acid is consumed as determined by a measured acidic index of 0 mg KOH/g, the mixture is cooled to 50° C. The reaction product (101) is obtained as a yellow brownish solid in a yield of 91%.

FT-IR vₘₐₓ (liquid film) main bands [cm⁻¹]: 3292.2, 3083.6, 2926.3, 2855.7, 1648.8, 1559, 1462.7

¹³C NMR (126 MHz, Chloroform-d): δ 173.04 (C-6), 130.19 (double bonds), 130.03 (double bonds), 129.97 (double bonds), 129.74 (double bonds), 128.05 (double bonds), 127.92 (double bonds), 58.60 (C-2), 45.39 (C-10, C-11), 39.19 (C-4), 36.95 (C-7), 31.93, 31.91, 31.53, 29.78, 29.75, 29.70, 29.67, 29.65, 29.53, 29.43, 29.36, 29.33, 29.18, 27.22 (C-21, C-24), 26.28 (C-3), 25.79 (C-34), 25.64, 22.69, 22.58, 14.11 (C-13).

A-2: Reaction Product of Soy Oil Fatty Acid and 1,3-diaminopropane (102)

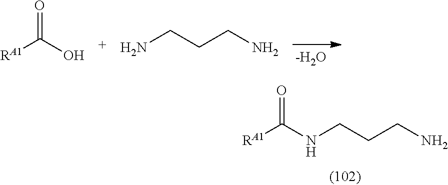

A stirred solution of distilled soy oil fatty acid (410 g SOFA-1, 1.5 mol, represented by R^{A1}-C(═O)OH in the reaction scheme) is heated to 40° C. and 1,3-diaminopropane (144 g, 1.95 mol; molar ratio of R^{A1}-C(═O)OH to 1,3-diaminopropane is 1 to 1.3) is added in 5 minutes. The addition causes an exothermic reaction due to a salt formation. After complete addition, the reaction mixture is quickly heated until 80° C. and then heated slowly until 180° C. in 1.5 hours. The mixture is kept at reflux at 180° C. for 2.5 hours. Afterwards, water is distilled. Then, the reaction mixture is kept under vacuum for one hour. The acidic index is measured by titration with KOH solution (0.05 mol/L) to identify the end of the reaction by using 50 mL neutralized ethanol as solvent and phenolphthalein as indicator. After all the fatty acid is consumed as determined by a measured acidic index of 0 mg KOH/g, the mixture is cooled to 50° C. The reaction product (102) is obtained as a yellow brownish solid. In the reaction scheme, N-(3-aminopropyl)amide derivatives are depicted. It is assumed that due to a further intramolecular condensation reaction, the reaction product contains also 2-R^{A1}-1,4,5,6-tetrahydropyrimidine derivatives.

¹H NMR (400.33 MHz, Chloroform-d): δ 6.28 (double bonds), 5.93 (double bonds), 5.65 (double bonds), 5.33 (double bonds), 3.31 (C12, C14), 3.25 (C5), 2.76 (CH₂ besides C═C), 2.15 (CH₂ besides C═O), 2.01 (CH₂ besides C═O), 1.77 (C6, C13), 1.59, 1.28, 0.88 (CH₃ aliphatic chain).

A-3: Reaction Product of Soy Oil Fatty Acid and 1,3-diaminopentane

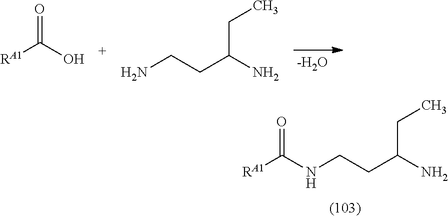

A stirred solution of distilled soy oil fatty acid (410 g SOFA-1, 1.5 mol, represented by R^{A1}—C(═O)OH in the reaction scheme) is heated to 40° C. and 1,3-diaminopentane (199 g, 1.95 mol; molar ratio of R^{A1}—C(═O)OH to 1,3-diaminopentane is 1 to 1.3) is added in 5 minutes. The addition causes an exothermic reaction due to a salt formation. After complete addition, the reaction mixture is quickly heated until 80° C. and then slowly heated until 150° C. in 1.5 hours. The mixture is kept at reflux at 150° C. for one hour. Afterwards, water is distilled. Then, the reaction temperature is slowly raised until 180° C. and kept at this temperature for 2.5 hours. The acidic index is measured by titration with KOH solution (0.05 mol/L) to identify the end of the reaction by using 50 mL neutralized ethanol as solvent and phenolphthalein as indicator. After all the fatty acid is consumed as determined by a measured acidic index of 0 mg KOH/g, the mixture is cooled to 50° C. The reaction product is obtained as a yellow brownish solid. In the reaction scheme above, expected N-(3-aminopentyl)amide derivatives (103) are depicted. It is assumed that the reaction product contains also N-(3-amino-1-ethyl-propyl)amide derivatives. It is further assumed that due to a further intramolecular condensation reaction, the reaction product contains also 2-R^{A1}-4-ethyl-1,4,5,6-tetrahydropyrimidine derivatives or 2-R^{A1}-6-ethyl-1,4,5,6-tetrahydro-pyrimidine derivatives. However, as the expected N-(3-aminopentyl)amide derivatives (103) is not identifiable in the ¹H NMR data shown below, example A-3 is disregarded.

¹H NMR (400.33 MHz, Chloroform-d): 6.28 (double bonds), 5.93 (double bonds), 5.66 (double bonds), 5.33 (double bonds), 3.36 (C-8), 3.30 (C-3), 2.76 (CH₂ besides C═C), 2.38, 2.14, 2.04, 1.99, 1.73, 1.61, 1.45, 1.25, 0.96 (C-9, CH₃ aliphatic chain), 0.88 (CH₃ aliphatic chain).

A-4: Reaction Product of Soy Oil Fatty Acid and Diethylenetriamine (104)

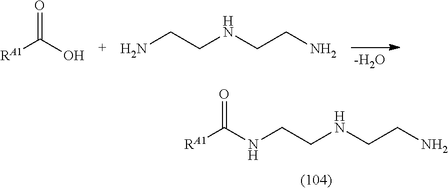

A stirred solution of distilled soy oil fatty acid (410 g SOFA-1, 1.5 mol, represented by R^{A1}—C(═O)OH in the reaction scheme) is heated to 40° C. and diethylenetriamine (155 g, 1.5 mol; molar ratio of R^{A1}—C(═O)OH to diethylenetriamine is 1 to 1) is added in 5 minutes. The addition causes an exothermic reaction due to a salt formation. After complete addition, the reaction mixture is heated until 80° C. automatically, and then heated slowly until 180° C. in 1.5 hours. The mixture is kept at reflux at 180° C. for two hours and water is distilled. Then, the reaction mixture is kept under vacuum (−700 mm Hg respectively 93 kPa below atmospheric pressure) for one hour. The acidic index is measured by titration with KOH solution (0.05 mol/L) to identify the end of the reaction by using 50 mL neutralized ethanol as solvent and phenolphthalein as indicator. After all the fatty acid is consumed as determined by a measured acidic index of 0 mg KOH/g, the mixture is cooled to 50° C. The reaction product (104) is obtained as a yellow brownish solid. In the reaction scheme, N-[2-(2-aminoethylamino)ethyl]amide derivatives are depicted. It is assumed that due to a further intramolecular condensation reaction, the reaction product contains also 2-(2-R^{A1}-4,5-dihydroimidazol-1-yl)ethanamine derivatives.

¹H NMR (400.33 MHz, Chloroform-d): 6.86 (double bonds), 6.25 (double bonds), 6.01 (double bonds), 5.35 (double bonds), 3.68 (C21), 3.39 (C4, C20), 3.28, 3.19 (C8, C11, C15), 3.12, 2.84 (C12, C14), 2.77 (C5, C7 +CH₂ besides C═C), 2.17 (C23, C24), 2.04 (CH₂ besides C═O), 1.62 (CH₂-chain), 1.31 (CH₂-chain), 1.25 (CH₂-chain), 0.97 (CH₃ aliphatic chain), 0.88 (CH₃ aliphatic chain).

B) Non-Ionic Collector

B-1: C13-C15 oxo-alcohol 3EO (201) (for Inventive Example)

50% aqueous KOH (3.9 g) are added to C₁₃-C₁₅ oxo-alcohol (535 g=2.5 mol, primary alcohol, C₁₃ to C₁₅ molar ratio around 1, linear compounds and mono-branched compounds, average degree of branching around 0.6) and water is removed at 100° C. and 20 mbar over 2 h. The mixture is transferred into a 5 L reactor which is flushed three times with nitrogen and heated to 130° C. under 2 bar pressure. Ethylene oxide (330 g=7.5 mol) is added as follows: 80 g are injected over the first 15 min and the rest over 4 h. The reaction mixture is stirred over 2 h at 130° C., then cooled to ambient temperature. The catalyst is neutralized with acetic acid (2.1 g). The obtained product (201) is used without further purification.

B-2: C₁₆-C_{18:1} Linear Alcohol 2EO (202) (for Inventive Example)

50% aqueous KOH (3.9 g) are added to a distilled tallow oleic alcohol (665 g=2.5 mol, tallow oleic alcohol is based on a natural raw material, the molar ratio between cetyl alcohol [hexadecane-1-ol, 242.4 g/mol] and oleyl alcohol [(Z)-octadec-9-en-1-ol, 268.5 g/mol] is 10 cetyl alcohol to 90 oleyl alcohol based on 100 for the molar sum of all cetyl alcohol and all oleyl alcohol [average molecular weight 265.9 g/mol], the amount of ethylene oxide has accordingly to be adjusted for a respective ratio of equivalents of ethylene oxide to one equivalent of hydroxy group of the alcohol) and water is removed at 100° C. and 20 mbar over 2 h. The mixture is transferred into a 5 L reactor which is flushed three times with nitrogen and heated to 130° C. under 2 bar pressure. Ethylene oxide (220 g=5 mol) is added as follows: 80 g were injected over the first 15 min and the rest over 4 h. The reaction mixture is stirred over 2 h at 130° C., then cooled to ambient temperature. The catalyst is neutralized with acetic acid (2.1 g). The obtained product (202) is used without further purification.

B-3: iso-C₁₃ oxo-alcohol 3 EO (203) (for Comparative Example)

50% aqueous KOH (3.9 g) are added to iso-tridecanol (500 g=2.5 mol, primary iso-C13 oxo-alcohol, which is obtained from trimerization of butene followed by hydroformylation, double-branched compounds and triple-branched compounds, average degree of branching between 2.0 and 2.5) and water is removed at 100° C. and 20 mbar over 2 h. The mixture is transferred into a 5 L reactor which is flushed three times with nitrogen and heated to 130° C. under 2 bar pressure. Ethylene oxide (330 g=7.5 mol) is added as follows: 80 g are injected over the first 15 min and the rest over 4 h. The reaction mixture is stirred over 2 h at 130° C., then cooled to ambient temperature. The catalyst is neutralized with acetic acid (2.1 g). The obtained product (203) is used without further purification.

C) Flotation Auxiliary

St-1: Causticized Starch

4 g corn starch and 50 g of distilled water are added in a 600 mL beaker. 1 g of an aqueous 50 wt. % NaOH solution is added and energetically mixed for 10 minutes until it acquires a gel appearance. 345 g of distilled water are added to the mixture and a homogenization is made with a magnetic stirrer for 5 minutes to obtain a solution of causticized starch St-1.

D) Collector Solution

An aqueous collector solution is prepared by dissolving an amidoamine, i.e. the obtained reaction product, and optionally a non-ionic collector, i.e. the obtained reaction product, in a relative weight ratio, as stated in table D-1 in water in an amount to obtain a 1 wt. % aqueous collector solution.

TABLE D-1

| collector | amidoamine | | non-ionic | |
|---|---|---|---|---|
| solution No. | collector | amount ^{c)} | collector | amount ^{c)} |
| D-1-1 ^{a)} | (101) | 100 | — | — |
| D-1-2 ^{b)} | (101) | 90 | (201) | 10 |
| D-1-3 ^{a)} | (102) | 100 | — | — |
| D-1-4 ^{b)} | (102) | 90 | (201) | 10 |
| D-1-5 ^{b)} | (102) | 98 | (202) | 2 |
| D-1-6 ^{a)} | (104) | 100 | — | — |
| D-1-7 ^{b)} | (104) | 90 | (201) | 10 |
| D-1-8 ^{b)} | (104) | 98 | (202) | 2 |
| D-1-9 ^{a)} | (104) | 90 | (203) | 10 |

Footnote:
^{a)} comparative
^{b)} inventive
^{c)} parts by weight based on 100 parts by weight of the sum of the amidoamine and if present of the non-ionic collector

E) Calculation of Selectivity

A measure of selectivity for the valuable mineral and against the gangue can be Separation Efficiency (SE) defined as SE=Rv-RG, with Rv being recovery of the valuable element and RG being the recovery of gangue as described in “Separation Efficiency” by Norman F. Schulz, Society of Mining Engineers of AIME, pre-print No. 69-B-44, paper to be presented at the Annual Meeting of the American Institute of Mining, Metallurgical and Petroleum Engineers, Washington, D.C., 1969 (available in digitalized form for example at www.911metallurgist.com/separation-efficiency/). The same calculation can be made from element assays of the concentrate and tailings fraction and represented as

$$S E = 100 \frac{{c}_{m}}{f} [ \frac{( f - t ) ( c - f )}{( c - t ) ( {c}_{m} - f )} ] = 100 \frac{f - t}{c - t} [ \frac{c}{f} - \frac{{c}_{m} - c}{{c}_{m} - f} ]$$

where
c: atom content of desired element [wt. %] in the concentrate
cm: atom content of desired element [wt. %] in the mineral being concentrated
f: atom content of desired element [wt. %] in the feed
t: atom content of desired element [wt. %] in the tailings

The value of Separation Efficiency for an ideal separation is 100, however the real values are below that. The closer it is to 100, the better the separation and the recovery of valuable element.

In case of itabirite ore, the desired element is iron (Fe) and the mineral being concentrated is haematite Fe₂O₃ with an atom content of iron in the mineral of 69.9%. The gangue in an itabirite ore consists predominantly of quartz (SiO₂), which is determined as Si by WDXRF and recalculated as SiO₂ in the concentrate. For a calculation of Separation Efficiency, only the iron content of the fraction is used.

F) Flotation

F-1: Flotation of an Itabirite Type Iron Ore

500 g ground itabirite type iron ore (iron mainly contained as haematite, 43.9 wt. % Fe and 33.9 wt. % SiO₂) and 333 mL distilled water are placed in a 1.5 L flotation cell in a CDC flotation machine and agitated at 1000 rpm. The slurry is conditioned with causticized starch solution St-1 in an amount corresponding to 500 g starch per ton of dried ore (25 g of a causticized starch solution St-1 with 1 wt. % concentration) for 3 min. The pH is kept at 9.8 using 5 wt. % aqueous NaOH solution. Subsequently, approximately 7.5 or 10 g of 1 wt. % collector solution as described in the tables F-1-1 and F-1-2 corresponding to approximately 150 or 200 g collector per ton of dried ore is added to the slurry and conditioned for 1 min.

After conditioning, further 600 mL distilled water are added and the slurry is aerated at 1 L/min until the completion of the flotation (3 min). The froth fraction is collected and aeration stopped. The water level is maintained during the entire flotation time. The remaining cell fraction (further described as concentrate) and separated froth (further described as tailings) are dried in an oven at 100° C., weighed, homogenized, and their contents of Fe and Si are determined using EDXRF in a lithium borate fused bead matrix. The Si content is recorded as SiO₂. The results are listed in tables F-1-1 and F-1-2.

TABLE F-1-1

| example No. | F-1-1-1 ^{a)} | F-1-1-2 ^{b)} | F-1-1-3 ^{a)} | F-1-1-4 ^{b)} | F-1-1-5 ^{b)} |
|---|---|---|---|---|---|
| collector | D-1-1 | D-1-2 | D-1-3 | D-1-4 | D-1-5 |
| solution | | | | | |
| collector | (101) | (101) + | (102) | (102) + | (102) + |
| | | (201) | | (201) | (202) |
| amount ^{c)} | 100 | 90:10 | 100 | 90:10 | 98:2 |
| dosage [g/t] | 200 | 150 | 150 | 150 | 150 |
| SE ^{d)} | 83.9 | 85.9 | 81.6 | 83.8 | 87.4 |
| Fe grade | 66.9 | 66.5 | 67.1 | 66.9 | 67.0 |
| conc. ^{e)} | | | | | |
| [wt. %] | | | | | |
| SiO₂ conc. ^{f)} | 1.04 | 1.93 | 0.73 | 0.71 | 1.31 |
| wt. %] | | | | | |
| Fe tailings ^{g)} | 10.0 | 6.9 | 12.5 | 10.0 | 6.5 |
| [wt. %] | | | | | |
| SiO₂ | 86.4 | 91.4 | 82.7 | 84.5 | 91.3 |
| tailings ^{h)} | | | | | |
| [wt. %] | | | | | |
| Fe recovery | 92.4 | 95.2 | 90.6 | 92.0 | 94.8 |
| in conc. ⁱ⁾ | | | | | |
| [%] | | | | | |
| observations | | j) | | | j) |

Footnotes:
^{a)} comparative
^{b)} inventive
^{c)} relative weight parts of amidoamine collector and non-ionic collector based on the sum of 100 parts for the amidoamine collector and - if present - the non-ionic collector
^{d)} Separation Efficiency
^{e)} weight percentage of Fe in the cell concentrate
^{f)} weight percentage of SiO₂ in the cell concentrate
^{g)} weight percentage of Fe in the tailings (separated froth)
^{h)} weight percentage of SiO₂ in the tailings (separated froth)
ⁱ⁾ recovery of Fe in the cell concentrate based on overall Fe in the ore
j) higher but still acceptable SiO₂ content in concentrate offset by lower Fe losses into tailings

TABLE F-1-2

| example No. | F-1-2-1 ^{a)} | F-1-2-2 ^{b)} | F-1-2-3 ^{b)} | F-1-2-4 ^{a)} |
|---|---|---|---|---|
| collector | D-1-6 | D-1-7 | D-1-8 | D-1-9 |
| solution | | | | |
| collector | (104) | (104) + | (104) + | (104) + |
| | | (201) | (202) | (203) |
| amount ^{c)} | 100 | 90:10 | 98:2 | 90:10 |
| dosage [g/t] | 200 | 150 | 200 | 200 |
| SE ^{d)} | 76.4 | 83.9 | 83.2 | 75.9 |
| Fe grade conc. ^{e)} | 67.2 | 67.4 | 67.3 | 67.2 |
| [wt. %] | | | | |
| SiO₂ conc. ^{f)} | 0.77 | 0.85 | 1.03 | 0.83 |
| [wt. %] | | | | |
| Fe tailings ^{g)} | 17.0 | 10.9 | 11.4 | 17.4 |
| [wt. %] | | | | |
| SiO₂ tailings ^{h)} | 76.1 | 84.2 | 83.4 | 74.0 |
| [wt. %] | | | | |
| Fe recovery in | 83.3 | 91.2 | 90.4 | 84.6 |
| conc. ⁱ⁾ [%] | | | | |
| observations | | j) | j) | k) |

Footnotes:
^{a)} comparative
^{b)} inventive
^{c)} relative weight parts of amidoamine collector and non-ionic collector based on the sum of 100 parts for the amidoamine collector and - if present - the non-ionic collector
^{d)} Separation Efficiency
^{e)} weight percentage of Fe in the cell concentrate
^{f)} weight percentage of SiO₂ in the cell concentrate
^{g)} weight percentage of Fe in the tailings (separated froth)
^{h)} weight percentage of SiO₂ in the tailings (separated froth)
ⁱ⁾ recovery of Fe in the cell concentrate based on overall Fe in the ore
j) higher but still acceptable SiO₂ content in concentrate offset by lower Fe losses into tailings
k) not acceptable results due to high Fe loss into tailings and lower SE compared with the amidoamine itself

The results in tables F-1-1 and F-1-2 show that the use of inventive collector compositions comprising amidoamine collector and non-ionic collector result in an improved separative performance in comparison to a use of the amidoamine collector alone. The comparison of the results of the inventive example F-1-2-2 versus the comparative examples F-1-2-1 and F-1-2-4 show that not each non-ionic collector is suitable for a combination with an amidoamine collector respectively that an average degree of branching above 1 is detrimental for the combination. Concerning a SiO₂ content in the concentrate, it is noted that each mine site establishes its commercially acceptable upper limit, for example <2 wt. % SiO₂ in the concentrate. The Fe grade conc. values are influenced by the wt. % SiO₂ in the concentrate, which means that if the commercially acceptable upper limit of SiO₂ content in the concentrate is reached, the Fe recovery is decisive for a performance of a collector.

1. A method for manufacturing a concentrate enriched in iron mineral content from an ore, which contains an iron mineral and silicate, by a reverse flotation, characterized that said method comprises the step of
(c) adding a collector composition comprising
(i) an amidoamine, which contains a compound of formula I 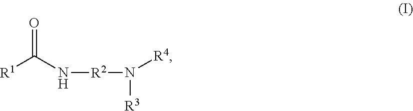
wherein
R¹ is a linear or branched aliphatic C₇-C₁₉ alkyl or a linear C₇-C₁₉ aliphatic alkenyl,
R² is a linear or branched aliphatic C₂-C₆ alkylene,
R³ and R⁴ are independently from each other H, C₁-C₂ alkyl or a substituent of formula I-S
*-[—(CH₂—)ₚ—NH—]_{q}—(CH₂—)ₚ—NH₂ (I-S)
wherein
p is 2, 3 or 4,
q is 0, 1, 2 or 3, and
* represents the connecting site of the substituent, or
a salt of a protonated compound of formula I and an anion;
(ii) an ethoxylate, which contains a compound of formula II
R^{E}—O—(—CH₂—CH₂—O—)ₙ—H (II),
wherein
R^{E} is a linear or mono-branched aliphatic C₁₀-C₂₀ alkyl or a linear aliphatic C₁₀-C₂₀ alkenyl,
n is an integer from 1 to 12,
to a prepared aqueous pulp of the ore and optionally one or more flotation auxiliary to obtain an aqueous mixture.

2. The method according to claim 1, wherein the method comprises the steps of
(a) providing the ore, which contains an iron mineral and silicate,
(b) preparing from the provided ore by addition of water and optionally one or more flotation auxiliaries an aqueous pulp,
(c) adding the collector composition to the prepared aqueous pulp of the ore and optionally one or more flotation auxiliaries to obtain an aqueous mixture,
(d) aerating the aqueous mixture in a flotation cell to generate a froth, which is enriched in silicate content, and removing the generated froth from the flotation cell,
(e) obtaining from the flotation cell the concentrate enriched in iron mineral content.

3. The method according to claim 1, wherein
(i) the amidoamine contains different compounds of formula I, or
salts of the protonated different compounds of formula I and an anion;
(ii) the ethoxylate contains different compounds of formula II.

4. The method according to claim 1 wherein
the amidoamine is obtainable by condensation of a fatty acid of formula I-FA with an amine of formula I-A 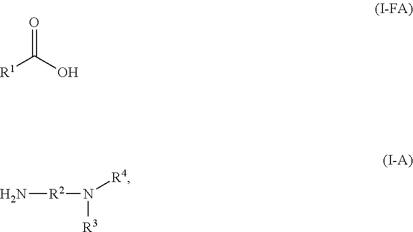
wherein R¹, R², R³, R⁴ and formula I-S, p, q and * are defined as in claim claim 1.

5. The method according to claim 1, wherein
(ii) the ethoxylate is obtainable by ethoxylation of one equivalent of an alcohol of the formula II-AL
R^{E}—OH (II-AL),
wherein R^{E} is defined as in claim 1, with n equivalents of ethylene oxide,
wherein n is defined as in claim 1.

6. The method according to claim 1, wherein the collector composition comprises
(i) an amidoamine, which contains a compound of formula I 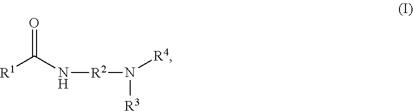
wherein
R¹ is a linear or branched aliphatic C₁₁-C₁₉ alkyl or a linear C₁₁-C₁₉ aliphatic alkenyl,
R² is a linear or branched aliphatic C₂-C₆ alkylene,
R³ and R⁴ are independently from each other H, C₁-C₂ alkyl or a substituent of formula I-S
*-[—(CH₂—)ₚ—NH—]_{q}—(CH₂—)ₚ—NH₂ (I-S)
wherein
p is 2, 3 or 4,
q is 0, 1, 2 or 3, and
* represents the connecting site of the substituent, or
a salt of a protonated compound of formula I and an anion, and
which is obtainable by condensation of a fatty acid of formula I-FA with an amine of formula I-A 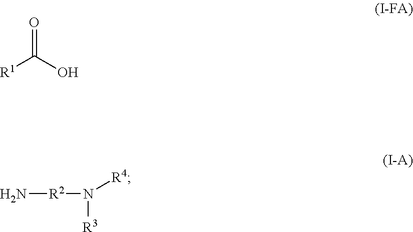
(ii) an ethoxylate, which contains a compound of formula II
R^{E}—O—(—CH₂—CH₂—O—)ₙ—H (II)
wherein
R^{E} is a linear or mono-branched aliphatic C₁₀-C₂₀ alkyl or a linear aliphatic C₁₀-C₂₀ alkenyl,
n is an integer from 1 to 12, and
which is obtainable by ethoxylation of one equivalent of an alcohol of formula II-AL
R^{E}—OH (II-AL)
with n equivalents of ethylene oxide.

7. The method according to claim 1, wherein the collector composition comprises more parts by weight of the amidoamine than of the ethoxylate, and the sum of the amidoamine and the ethoxylate is 100 parts by weight.

8. The method according to claim 1 wherein the collector composition comprises
(i) 65 to 99 parts by weight of the amidoamine, and
(ii) 1 to 35 parts by weight of the ethoxylate,
and the sum of the amidoamine and the ethoxylate is 100 parts by weight.

9. The method according to claim 1, wherein the collector composition comprises
(i) 75 to 99 parts by weight of the amidoamine, and
(ii) 1 to 25 parts by weight of the ethoxylate,
and the sum of the amidoamine and the ethoxylate is 100 parts by weight.

10. The method according to claim 1 wherein the collector composition comprises
(i) 85 to 99 parts by weight of the amidoamine, and
(ii) 1 to 15 parts by weight of the ethoxylate,
and the sum of the amidoamine and the ethoxylate is 100 parts by weight.

11. The method according to claim 1, wherein (a) R³ is H or C₁-C₂ alkyl, (b) p is 2 and q is 1, 2 or 3, (c) n is 1, 2, 3 or 4, (d) R^{E} is a linear or mono-branched aliphatic C₁₂-C₁₈ alkyl or a linear aliphatic C₁₈ alkenyl or any combination of (a) to (d).

12. (canceled)

13. (canceled)

14. (canceled)

15. The method according to claim 1, wherein in case the ethoxylate contains only compounds of formula II with the same RE, the same RE is linear, or in case the ethoxylate contains compounds of formula II with two or more different RE, an average degree of branching of RE for all the compounds of formula II is between 0 and 0.8.

16. The method according to claim 15, wherein R^{E} is linear.

17. The method according to claim 1, wherein the anion is C₁-C₁₈ carboxylate, fluoride, chloride, bromide, iodide, sulfonate, hydrogensulfate, sulfate, dihydrogenphosphate, hydrogenphosphate, phosphate, nitrate, hydrofluorosilicate or fluorosilicate.

18. The method according to claim 1, wherein the collector composition is added in an amount between 10 g to 500 g per ton of the ore.

19. The method according to claim 1, wherein the pH value at step (c) is between 8 and 12.

20. The method according to claim 1, wherein the collector composition is added as an aqueous solution or suspension.

21. The method according to any preceding claim 1, wherein at step (b) one or more flotation auxiliary is added and one of the flotation auxiliary is a depressing agent, a froth regulator, a co-collector or an extender oil.

22. The method according to claim 21, wherein a depressing agent, which is starch, is added.

23. (canceled)

24. A collector composition, comprising
(i) an amidoamine, which contains a compound of formula I 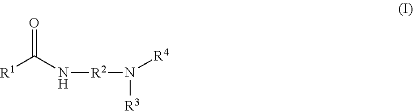
wherein
R¹ is a linear or branched aliphatic C₇-C₁₉ alkyl or a linear C₇-C₁₉ aliphatic alkenyl,
R² is a linear or branched aliphatic C₂-C₆ alkylene,
R³ and R⁴ are independently from each other H, C₁-C₂ alkyl or a substituent of formula I-S
*-[—(CH₂—)ₚ—NH—]_{q}—(CH₂—)ₚ—NH₂ (I-S)
wherein
p is 2, 3 or 4,
q is 0, 1, 2 or 3, and
* represents the connecting site of the substituent, or
a salt of a protonated compound of formula I and an anion;
(ii) an ethoxylate, which contains a compound of formula II
R^{E}—O—(—CH₂—CH₂—O—)ₙ—H (II)
wherein
R^{E} is a linear or mono-branched aliphatic C₁₀-C₂₀ alkyl or a linear aliphatic C₁₀-C₂₀ alkenyl, and
n is an integer from 1 to 12.
